(19) United States
(12) Patent Application Publication
(10) Pub. No.: US 2025/0269332 A1
(43) Pub. Date: Aug. 28, 2025

(54) Modular Membrane Materials for Separation Systems and Methods of Use thereof

(71) Applicant: Temple University-Of The Commonwealth System of Higher Education, Philadelphia, PA (US)

(72) Inventor: Rouzbeh Afsarmamesh Tehrani, Radnor, PA (US)

(21) Appl. No.: 19/063,965

(22) Filed: Feb. 26, 2025

Related U.S. Application Data
(60) Provisional application No. 63/557,847, filed on Feb. 26, 2024.

(51) Int. Cl. B01D 69/02; B01D 67/00; B01D 69/14; B01D 71/02

(52) U.S. Cl. CPC B01D 69/02; B01D 67/0081; B01D 69/144; B01D 71/0223; B01D 2323/35; B01D 2325/46

(57) ABSTRACT

In one aspect, the present invention relates to a membrane material having a first surface, an opposing second surface and a thickness between the first and second surfaces; the membrane material comprising a mineral comprising a metal; and at least one channel between the first surface and the second surface, wherein the channel has a diameter of less than 1 mm.

In one aspect, the present invention relates to a system comprising the membrane material. In one aspect, the present invention relates to a method of purifying a fluid, using said systems and membrane materials.

### CROSS REFERENCE TO RELATED APPLICATIONS

The present application claims priority to U.S. Provisional Application No. 63/557,847, filed Feb. 26, 2024, which is incorporated by reference herein in its entirety.

### BACKGROUND OF THE INVENTION

Current membrane separation systems face several significant limitations that hinder their broader application and efficiency. One of their primary challenges is fouling, where the accumulation of particles or biological growth on the membrane surface leads to reduced permeability and necessitates frequent cleaning or replacement. These membranes often face challenges with chemical and thermal stability under harsh operational conditions, which can significantly limit their lifespan and reliability. Additionally, there is an inherent trade-off between selectivity and permeability. High selectivity, which enables the precise passive and active transport of target ions at the molecular and ionic levels, typically leads to lower flux rates. This reduction in flux diminishes the overall efficiency of the process. Scalability of these systems for industrial applications also presents economic challenges due to high capital and operational costs. The environmental impact of disposing non-biodegradable membrane materials further exacerbates sustainability concerns.

Membrane systems often lack the responsiveness to dynamically adjust their properties or separation performance in response to fluctuating environmental conditions or varying feed compositions, which restricts their adaptability in real-world scenarios. Addressing these limitations requires a multifaceted approach, which includes the development of advanced materials, innovative membrane technologies, and the incorporation of responsive and adaptive mechanisms. These strategies aim to enhance performance, improve environmental compatibility, and increase the flexibility of membrane separation systems.

Pyrite nanocrystals are the focus of extensive research for their potential use in various applications, driven by their unique optical, electrical, and catalytic properties. In photovoltaics, pyrite is explored for thin-film solar cells as a cost-effective and plentiful alternative to conventional materials. In the realm of energy storage, pyrite is instrumental in enhancing the performance of lithium-sulfur and sodium-sulfur batteries by increasing energy densities and prolonging cycle lives. Its high optical absorption capacity also makes it suitable for photodetectors, facilitating the conversion of light into electrical signals over a broad spectrum. Furthermore, pyrite's catalytic capabilities are utilized in environmental remediation for pollutant degradation and in electrocatalysis for hydrogen production.

It would be advantageous if one could take the electrical and magnetic properties of pyrite and leverage them for use in modular membrane separation systems. Thus, there remains a need in the art for membrane separation units. The present invention satisfies this unmet need.

### SUMMARY OF THE INVENTION

In one aspect, the present invention relates to a membrane material having a first surface, an opposing second surface and a thickness between the first and second surfaces; the membrane material comprising a mineral comprising a metal selected from the group consisting of iron, boron, indium, lithium, aluminum, magnesium, titanium, vanadium, manganese, gadolinium, neodymium, molybdenum, and combinations thereof; and at least one channel between the first surface and the second surface, wherein the channel has a diameter of less than 1 mm.

In one embodiment, the mineral is pyrite (Fe₂S) and the membrane material further comprises a rare-earth metal. In one embodiment, the rare-earth metal is selected from the group consisting of erbium, europium, gadolinium, neodymium, uranium, thorium, plutonium, neptunium, americium, curium and combinations thereof. In one embodiment, the membrane material further comprises a microorganism. In one embodiment, the microorganism is bacteria. In one embodiment, the pH of the membrane material is below 7. In one embodiment, the membrane material forms a cylinder with the at least one channel passing through the length of the cylinder. In one embodiment, the membrane material forms a sheet with the at least one channel passing through the thickness of the sheet.

In one aspect, the present invention relates to a purification system comprising: a first chamber and a second chamber, wherein the membrane material is positioned between the first chamber and the second chamber and configured to permit a fluid to pass from the first chamber into the second chamber through the membrane material; a power supply; and at least one magnet electrically connected to the power supply, the at least one magnet configured to generate a magnetic field, wherein the at least one magnet is positioned adjacent to the membrane material such that at least a portion of the membrane material resides within the generated magnetic field.

In one embodiment, the membrane material is configured to change in size, shape, surface charge, tortuosity, or combinations thereof, in response to the generated magnetic field. In one embodiment, the change in the membrane material comprises a change in size, shape, surface charge, tortuosity, or combinations thereof, of the at least one channel. In one embodiment, the change in the membrane material responsive to the generated magnetic field comprises an increased diameter of the at least one channel. In one embodiment, the change in the membrane material responsive to the generated magnetic field comprises a decreased diameter of the at least one channel. In one embodiment, the change in the membrane material responsive to the generated magnetic field comprises a gradual increase in diameter of the at least one channel towards the first surface of the membrane material. In one embodiment, the change in the membrane material responsive to the generated magnetic field comprises a gradual decrease in diameter of the at least one channel towards the second surface of the membrane material. In one embodiment, the change in the membrane material responsive to the generated magnetic field comprises a gradual increase in diameter of the at least one channel towards the first surface of the membrane material and a gradual decrease in diameter of the at least one channel towards the second surface of the membrane material. In one embodiment, the at least one channel comprises at least two channels, wherein the change in the membrane material responsive to the generated magnetic field comprises a first change in diameter of a first channel and a second change in diameter of a second channel, wherein the first and second changes in diameter are different.

In one embodiment, the at least one magnet is a magnetic coil. In one embodiment, the power supply is communicatively connected to a computing environment configured to control the generation of the magnetic field via the power supply. In one embodiment, the computing environment is controlled by an artificial intelligence unit. In embodiment, the system further comprises a sensor selected from the group consisting of: glass electrode pH sensors, ion-sensitive field-effect transistor sensors, calorimetric sensors, optical sensors (absorbance/transmittance), conductivity sensors, refractometers, near-infrared sensors, resistance temperature detectors, thermocouples, thermistors, infrared sensors, multi-parameter probes, wireless sensors, photoionization detectors, flame ionization detectors, and combinations thereof. In one embodiment, the sensors measure at least one parameter is selected from the group consisting of: pH, conductivity, pressure, humidity, gas concentrations, velocity of fluids and particulates, magnetic fields, temperature, concentration of specific salts, ions, and molecules, and combinations thereof.

In one embodiment, the system further comprises an electromagnetically shielding material selected from the group consisting of: conductive silicone rubbers, carbon-black filled rubbers, silver-coated rubbers, graphene-based rubbers, metal-loaded rubbers, thermoplastic elastomers with conductive fillers, polyurethane elastomers with conductive carbon, natural rubber with conductive fillers, and combinations thereof. In one embodiment, the system further comprises an electromagnetically responsive material selected from the group consisting of: piezoelectric materials, ferromagnetic particles, conductive polymers, photonic crystals, graphene, magnetic materials, magnetic minerals, rare-earth elements, superconducting materials, plasmonic materials, and combinations thereof.

In one aspect, the present invention relates to a method of purifying a fluid, the method comprising the steps of: passing a feed solution comprising a particulate through a membrane material, the membrane material comprising a mineral comprising a metal selected from the group consisting of iron, boron, indium, lithium, aluminum, magnesium, titanium, vanadium, manganese, gadolinium, neodymium, molybdenum, and combinations thereof, the membrane material further comprising at least one channel through a thickness of the membrane material, wherein the channel has a diameter of less than 1 mm; absorbing the particulate in the membrane material to create a recovery solution; and collecting at least one of the recovery solution and the particulate.

In one embodiment, the method further comprises the steps of: applying a magnetic field or an electrical stimulus to at least a portion of the membrane material; and changing the membrane material in size, shape, surface charge, tortuosity, or combinations thereof, in response to the applied magnetic field or electrical stimulus. In one embodiment, the change in the membrane material responsive to the applied magnetic field or electrical stimulus comprises an increased diameter of the at least one channel. In one embodiment, the change in the membrane material responsive to the applied magnetic field or electrical stimulus comprises a decreased diameter of the at least one channel. In one embodiment, the change in the membrane material responsive to the applied magnetic field or electrical stimulus comprises a gradual increase in diameter of the at least one channel towards the first surface of the membrane material. In one embodiment, the membrane material responsive to the applied magnetic field or electrical stimulus comprises a gradual decrease in diameter of the at least one channel towards the second surface of the membrane material. In one embodiment, the change in the membrane material responsive to the applied magnetic field or electrical stimulus comprises a gradual increase in diameter of the at least one channel towards the first surface of the membrane material and a gradual decrease in diameter of the at least one channel towards the second surface of the membrane material. In one embodiment, the change in the membrane material responsive to the applied magnetic field or electrical stimulus comprises a first change in diameter of a first channel and a second change in diameter of a second channel, wherein the first and second changes in diameter are different.

In one embodiment, the method further comprises the step of controlling application of the magnetic field or the electrical stimulus via a computing environment. In one embodiment, the method further comprises the step of controlling the computing environment via an artificial intelligence unit.

### BRIEF DESCRIPTION OF THE DRAWINGS

The following detailed description of various embodiments of the invention will be better understood when read in conjunction with the appended drawings. For the purpose of illustrating the invention, there are shown in the drawings illustrative embodiments. It should be understood, however, that the invention is not limited to the precise arrangements and instrumentalities of the embodiments shown in the drawings.

FIG. 1 depicts an image of an experiment where the pH of a pyrite mixture is being tested.

FIG. 2 depicts images of air being pumped into a pyrite mixture (left) and an image of a pyrite mixture being subject to a magnet (right).

FIG. 3 depicts images of pyrite mixtures being subject to different types of magnets.

FIG. 4 depicts an image of a pyrite mixture after being subject to a 96-well magnet plate.

FIG. 5 depicts an image of a pyrite mixture where coarse pyrite particles have accumulated.

FIG. 6 depicts images of the aerobic and anaerobic biosynthesis of pyrite hydrogels.

FIG. 7 depicts images of europium-pyrite composites formed in a petri dish.

FIG. 8 depicts images of neodymium-pyrite composites formed on a glass slide.

FIG. 9 depicts scanning electron microscopy (SEM) images of neodymium-iron scaffolds.

FIG. 10 depicts a SEM image of a neodymium-pyrite composite formed on a glass slide.

FIG. 11 depicts SEM images of graphene oxide-neodymium-pyrite composites formed on a glass slide.

FIG. 12 depicts a SEM image and energy-dispersive x-ray spectroscopy (EDS) data of a graphene oxide-neodymium-pyrite composite formed on a glass slide.

FIG. 13 depicts energy-dispersive x-ray spectroscopy (EDS) data of a graphene oxide-europium-pyrite composite formed on a glass slide.

FIG. 14 depicts an image of a europium-pyrite composite with plasma added.

FIG. 15 depicts an image of a setup using plasma to form europium-pyrite composites and neodymium-iron composites.

FIG. 16 depicts images of the europium-iron composites and neodymium-pyrite composites formed using plasma.

FIG. 17 depicts SEM images of europium-pyrite composites.

FIG. 18 depicts a SEM image of europium-pyrite composites.

FIG. 19 depicts a SEM image of europium-pyrite composites.

FIG. 20 depicts a SEM image of europium-pyrite composites.

FIG. 21 depicts a SEM image of europium-pyrite composites.

FIG. 22 depicts a x-ray diffaction (XRD) diffactogram pattern of a europium-pyrite composite.

FIG. 23 depicts a XRD diffactogram pattern of a europium-pyrite composite.

FIG. 24 depicts a XRD diffactogram pattern of a europium-pyrite composite.

FIG. 25 depicts a SEM image of a neodymium-pyrite composite.

FIG. 26 depicts a SEM image of a neodymium-pyrite composite.

FIG. 27 depicts a SEM image of a neodymium-pyrite composite.

FIG. 28 depicts a SEM image of a neodymium-pyrite composite.

FIG. 29 depicts SEM images of a neodymium-pyrite composites.

FIG. 30 depicts SEM images of a neodymium-pyrite composites with naturally ocurring diatoms.

FIG. 31 depicts images of a lanthanide(s) phosphate formed in pyrite scaffolds.

FIG. 32 depicts images of electromagentic fields being used to expand hydrogels during biogenic synthsis.

FIG. 33 depicts a representation of modular systems being used in series or parallel arrangement.

FIG. 34 depicts a schematic of a membrane cross-section with localized tunable membrane pores.

FIG. 35 depicts a representation of induction coils being used to alter the membrane thickness of the hydrogels.

FIG. 35 depicts a representation of induction coils being used to alter the membrane thickness of a hydrogel with a ferromagnetic composition.

FIG. 36 depicts a representaiton of a ferromagnetic composition (circles) pulling the pore to become wider as an electromagnetic field is enforced.

FIG. 37 depicts a representaiton of electromagnetic fields being used to impose directional transmembrane mass transfer within a hydrogel.

FIG. 38 depicts a representation of a cross-section of electromagnetic pores during a purification phase.

FIG. 39 depicts a representation of a cross-section of electromagnetic pores during a cleaning phase.

FIG. 40 depicts a representation of a cross-section of electromagnetic pores during a purification phase where fluids leave the purification module without magnetic adsorbents.

FIG. 41 depicts a representation of a cross-section of electromagnetic pores with vertically oriented coils connected to a computing system.

FIG. 42 depicts a representation of a cross-section of electromagnetic pores with horizontally-oriented coils connected to a computing system.

FIG. 43 depicts a representation of artificial intelligence-operated bionic membranes.

FIG. 44 depicts a representation of an artificial intelligence-operated membrane design concept with localized sensory systems and localized voltage adjustments.

FIG. 45 depicts a representation of artificial intelligence-operated membrane design concept with localized sensory systems and localized magnetic pulses.

FIG. 46 depicts a block diagram of a membrane purification system.

FIG. 47 depicts a block diagram of a membrane purification system.

FIG. 48 depicts a block diagram of a membrane purification system.

FIG. 49 depicts a block diagram of a membrane purification system.

FIG. 50 depicts an exemplary membrane of the present application.

FIG. 51 depicts an exemplary coiled pore and imaging thereof.

FIG. 52 depicts an illustrative computer architecture for a computer.

FIG. 53 depicts SEM images of yttrium doped crystals grown under a magnetic field.

FIG. 54 depict a SEM image (left) and EDS data (right) of erbium crystals grown under a magnetic field

FIG. 55 depicts images of a tube filled with graphene oxide (left) and with graphite (right).

FIG. 56 depicts an image of a tube packed with grapene oxide creating a micro and nanoscale capillary pathway for uptake of fluids.

FIG. 57 depicts images of an overnight flow of water from a highly saturated sodium chloride solution (left) to an empty beaker (right).

FIG. 58 depicts an explemplary system of the application.

### DETAILED DESCRIPTION

It is to be understood that the Figures and descriptions of the present invention have been simplified to illustrate elements that are relevant for a clear understanding of the present invention, while eliminating, for the purpose of clarity, many other elements used in fluid purification. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

As used herein, each of the following terms have the meanings associated with it as specified below. Unless defined otherwise, all technical and scientific terms used herein generally have the same meaning as commonly understood by one of ordinary skill in the art to which this invention belongs.

The articles “a” and “an” are used herein to refer to one or to more than one (i.e. to at least one) of the grammatical object of the article. By way of example, “an element” means one element or more than one element.

As used herein, the term “about” will be understood by persons of ordinary skill in the art and will vary to some extent depending on the context in which it is used. As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

As used herein, the term “actuator” refers to a device in a machine that generates force, torque, or displacement in response to an electrical or electromagnetic input. Upon receiving electricity, the actuator converts electrical energy into mechanical motion, enabling it to perform precise tasks within an actuating system.

As used herein, the term “coil” refers to a wire coiled into a helical shape, commonly used in a variety of electrical applications.

As used herein, the term “dielectric elastomer actuators” (DEAs) refers to materials which rely on an electric field generated by applying a voltage across two electrodes. This field causes positive and negative changes within the dielectric elastomer to rearrange, creating electrostatic forces that induce deformation. The strength of the electric field directly controls the amount of deformation, allowing the actuator to produce mechanical movement.

As used herein, the term “dielectric” is an insulating material that can become polarized when exposed to an external electric field. During this process, the positive and negative charges within the dielectric material shift slightly in response to the field, resulting in an internal separation of charge. This polarization reduces the overall electric field within the material, which enhances the dielectric's ability to store electrical energy. Dielectrics are crucial in shaping the behavior of electric fields and are commonly used in capacitors to improve their energy storage capacity and efficiency.

As used herein, the term “elastomers” refers to polymers that exhibits viscoelasticity, meaning it has both viscosity and elasticity. It is characterized by weak intermolecular forces, a relatively low Young's modulus (E), and a high failure strain compared to other materials.

As used herein, the term “electrically conductive elastomers” refers to materials that blend elastomeric polymers with conductive fillers to create flexible, electrically conductive substances. The elastomer component of these materials is characterized by rubber-like properties, allowing for significant deformation while retaining their shape. This allows the gaskets to compress and act with high compliance in closing/electromagnetic interference (EMI) sealing gaps and service apertures in enclosures that house sensitive (or transmitting) electronics.

As used herein, the term “electrode” refers to an electrical conductor that contacts a nonmetallic part of a circuit, such as a semiconductor, electrolyte, vacuum, or gas.

As used herein, the term “electromagnetic shielding” refers to the process of attenuating or redirecting electromagnetic fields (EMF) within a given space using barriers made from conductive or magnetic materials. This technique is often employed in enclosures to isolate electrical devices from their environment. When specifically designed to block radio frequency (RF) electromagnetic radiation, this type of shielding is known as RF shielding.

As used herein, the term “solenoid” refers to an electromagnet consisting of a helical coil of wire, where the length of the coil is significantly greater than its diameter, generating a controlled magnetic field. When an electric current flows through the coil, it produces a uniform magnetic field within a designated space. This design allows for a magnetic field to be generated precisely when current passes through the coil. Solenoids are typically wound tightly in a cylindrical shape, leading to a higher concentration of magnetic field lines, which enhances the strength of the magnetic field.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Description

The present invention relates to membrane materials for separation systems and methods of use thereof.

### Membrane Materials

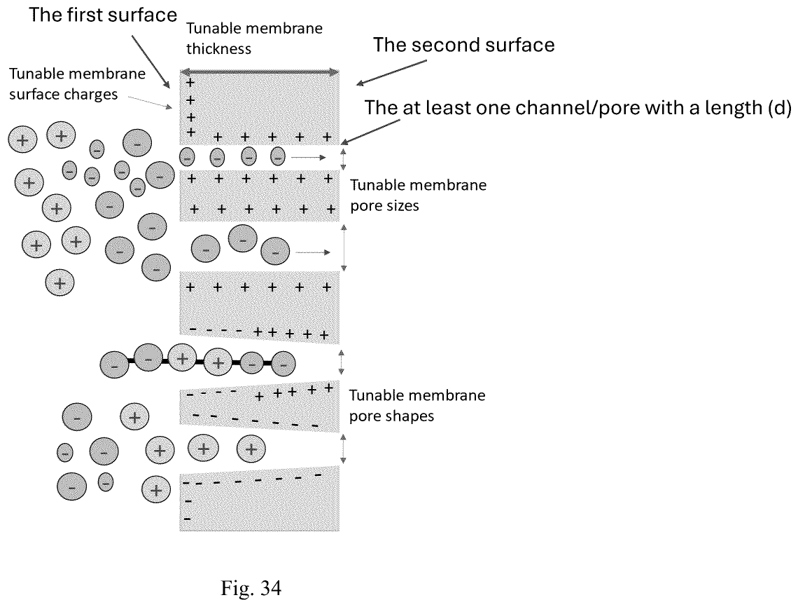

In some embodiments, as shown in FIG. 34, the present invention relates to a tunable membrane material having a first surface, an opposing second surface and a thickness between the first and second surfaces. The membrane material may include a mineral comprising a metal. Such metals may be, without limitation, iron, boron, indium, lithium, aluminum, magnesium, titanium, vanadium, manganese, gadolinium, neodymium, molybdenum, and combinations thereof. The membrane material can be any structural shape, such as a sheet of a desired thickness, or it may be any geometric shape, such as rectangular, cylindrical, round, trapezoidal, or random. The membrane material includes one or more pores or channels between the first surface and the second surface, where each pore or channel has a diameter of less than 1 mm.

In some embodiments, the diameter of the at least one channel is larger at the first surface than the diameter of the least one channel at the second surface. In some embodiments, the diameter of the at least one channel gradually increases towards the first surface of the membrane material. In some embodiments, the diameter of the at least one channel gradually decreases towards the first surface of the membrane material. In some embodiments, the diameter of the at least one channel gradually increases towards the first surface and gradually decreases towards the second surface. In some embodiments, the diameter of the at least one channel gradually decreases towards the first surface and gradually increases towards the second surface area.

In some embodiments, the membrane material is magnetic, or includes a component that is responsive to an electrical stimulus or to an electromagnetic field. In some embodiments, the membrane material includes a component that is responsive to a radiofrequency. In some embodiments, the membrane material is tunable, in that includes a component that responds to an external stimulus, by altering its size, shape, surface charge, tortuosity, and combinations thereof, can be altered upon being exposed. Exemplary external stimuli include, but are not limited to a magnetic field, an electrical current, an electromagnetic field, a radio frequency, and combinations thereof. In some embodiments, the membrane material is porous.

In some embodiments, the membrane material comprises a mineral. In some embodiments, the membrane material comprises a metal. In some embodiments, the membrane material comprises at least two minerals. In some embodiments, the membrane material comprises at least three minerals. In some embodiments, the membrane material comprises a rare-earth metal. In some embodiments, the membrane material comprises a homogeneous mixture of a metal and a mineral. In some embodiments, the membrane material comprises at least two rare-earth metals. In some embodiments, the minerals and/or metals are particles which are spherical in shape. In some embodiments, the minerals and/or metals are coarse particles. In some embodiments, the minerals and/or metals are smooth particles.

In some embodiments, the membrane material comprises a solvent. In some embodiments, the solvent is an organic solvent. In some embodiments, the solvent is an aqueous solvent. Exemplary solvents include but are not limited to, water, d-limonene, N-Methyl-2-pyrrolidone (NMP), 1-butyl-3-methylimidazolium chloride, and Cyclodextrins, tween 20, azocarboxamide, 2-methylpentane, and combinations thereof. In some embodiments, the membrane material is a gel. In some embodiments, the membrane material is a hydrogel. In some embodiments, the membrane material is a dry powder.

In some embodiments, the pH of the membrane material is below 13. In some embodiments, the pH of the membrane material is below 12. In some embodiments, the pH of the membrane material is below 11. In some embodiments, the pH of the membrane material is below 10. In some embodiments, the pH of the membrane material is below 9. In some embodiments, the pH of the membrane material is below 8. In some embodiments, the pH of the membrane material is below 7. In some embodiments, the pH of the membrane material is below 6. In some embodiments, the pH of the membrane material is below 5. In some embodiments, the pH of the membrane material is below 4. In some embodiments, the pH of the membrane material is below 3. In some embodiments, the pH of the membrane material is below 2.

In some embodiments, the pH of the membrane material is about 1. In some embodiments, the pH of the membrane material is about 2. In some embodiments, the pH of the membrane material is about 3. In some embodiments, the pH of the membrane material is about 4. In some embodiments, the pH of the membrane material is about 5. In some embodiments, the pH of the membrane material is about 6. In some embodiments, the pH of the membrane material is about 7. In some embodiments, the pH of the membrane material is about 8. In some embodiments, the pH of the membrane material is about 9. In some embodiments, the pH of the membrane material is about 10. In some embodiments, the pH of the membrane material is about 11. In some embodiments, the pH of the membrane material is about 12. In some embodiments, the pH of the membrane material is about 13. In some embodiments, the pH of the membrane material is about 14.

In some embodiments, the membrane material comprises chitosan particles. In some embodiments, the chitosan particles are functionalized. In some embodiments the membrane material comprises activated carbon. In some embodiments the membrane material comprises plasma. In some embodiments the membrane material comprises graphene oxide. In some embodiments, the membrane materials comprise a polymer. In some embodiments, the membrane materials comprise an organic polymer. In some embodiments, the membrane materials comprise carbon nanotubes. In some embodiments, the membrane materials comprises graphite.

In some embodiments, the membrane material comprises an inorganic material selected from the list of, but not limited to, manganese oxides (MnOₓ), iron oxides (Fe_{y}O_{z}), manganese sulfides (MnSₓ), molybdenum oxides (MoOₓ) such as birnessite, molybdenum sulfides (MoSₓ), molybdenum trioxide (MoO₃), silicon oxides (SiOₓ), silicon sulfides (SiSₓ), aluminum oxides (Al_{y}O_{z}), aluminum sulfides (Al_{y}S_{z}), boron oxides (B_{y}O_{z}), zeolites, alumina, bauxite, silica, activated clays, bauxite, iron oxide or hydroxide, hydroxyapatite, zirconium Oxide, calcium alginate, metal-organic frameworks, layered double hydroxides, boron nitride and magnesium hydroxide, sodium zirconium cyclosilicate (Lokelma), and any combination thereof.

In some embodiments, the membrane material comprises a two-dimensional material. In some embodiments, the two-dimensional material is a MXene material, including but are not limited to, Tᵢ₃AlC₂, Ti₃C, Niobium Carbide (Nb₂CTx), Chromium Carbide (Cr₂C), Vanadium carbide (V₂ CTx), Titanium Carbide (Ti₂CTx), and combinations thereof.

Exemplary rare earth metals of the invention include, but are not limited to, erbium, europium, gadolinium, neodymium, uranium, thorium, plutonium, neptunium, americium, cerium, and combinations thereof. In some embodiments, the rare earth metal has radioactive properties. In some embodiments, the rare-earth metal is used in spent-nuclear fuel separation and sensing.

In some embodiments, the mineral comprises a metal. Exemplary metals include, but are not limited to: boron, samarium, indium, tin, iron, europium, neodymium, chromium, titanium, cobalt, nickel, manganese, carbon, cerium, lanthanum, thorium, yttrium, aluminum, magnesium, calcium, copper, molybdenum, lead, gold, erbium, gadolinium, and combinations thereof.

In some embodiments, the mineral is magnetic. In some embodiments, the mineral comprises a rare-earth metal. In some embodiments, the mineral comprises at least two rare earth metals. In some embodiments, the rare-earth metal that the mineral comprises is from the lanthanide series. Examples of minerals include, but are not limited to: pyrite (FeS₂), magnetite (Fe₃O₄), hematite (Fe₂O₃), pyrrhotite (Fe(1−x)S), chromite (FeCr₂O₄), ilmenite (FeTiO₃), limonite (FeO(OH)·nH₂O), goethite (FeO(OH)), franklinite (ZnFe₂O₄), cobaltite (CoAsS), gersdorffite (NiAsS), ferric oxide (Fe₂O₃), manganite (MnO(OH)), siderite (FeCO₃), xenotime (YPO₄), spinel (MgAl₂O₄), wüstite (FeO), titanomagnetite (FeTiO₃), gadolinium oxide (Gd₂O₃), neodymium oxide (Nd₂O₃), neodymium sulfide (Nd₂S₃), gadolinium sulfide (Gd₂S₃), gadolinium oxysulfide (Gd₂O₂S), gadolinium boride (GdB₆), neodymium boride (NdB₆), and combinations thereof.

In some embodiments, the membrane material comprises a microorganism, including, but not limited to bacteria, viruses, fungi, algae, archaea, protozoa, and combinations thereof. In some embodiments, the microorganism is positioned on the first surface or the second surface of the membrane material, or both. In some embodiments, the microorganism is positioned on the surface within one or more pores or channels. In some embodiments, the microorganism is embedded within the thickness of the membrane material. In some embodiments, the microorganism is embedded within the at least one channel of the membrane material. In some embodiments, the algae are diatoms. In one embodiment, examples of bacteria include, but are not limited to, acidophilic bacteria, chemolithotrophic bacteria, sulfate-reducing bacteria, iron-reducing bacteria, dehalogenation bacteria, trichloroethylene and perchloroethylene degrading bacteria, polychlorinated biphenyl degrading bacteria, bacteria which degrades endocrine disrupting chemicals, and combinations thereof. In some embodiments, further examples of bacteria include, but are not limited to, Desulfovibrio species (spp.), Shewanella oneidensis, Desulfovibrio desulfuricans, Acidithiobacillus ferrooxidans, Leptospirillum ferrooxidans, Acidithiobacillus thiooxidans, Sulfobacillus spp., Dehalococcoides spp., Rhizobium spp. Pseudomonas spp. Geobacter spp. Sulfurospirillum spp., Pseudomonas spp., Dehalococcoides mccartyi, Sulfurospirillum multivorans, Sulfurospirillum halorespirans, Burkholderia xenovorans, Dehalococcoides mccartyi, Pseudomonas putida, Comamonas testosterone, Bacillus cereus, Rhodococcus erythropolis, Pseudomonas fluorescens and combinations thereof.

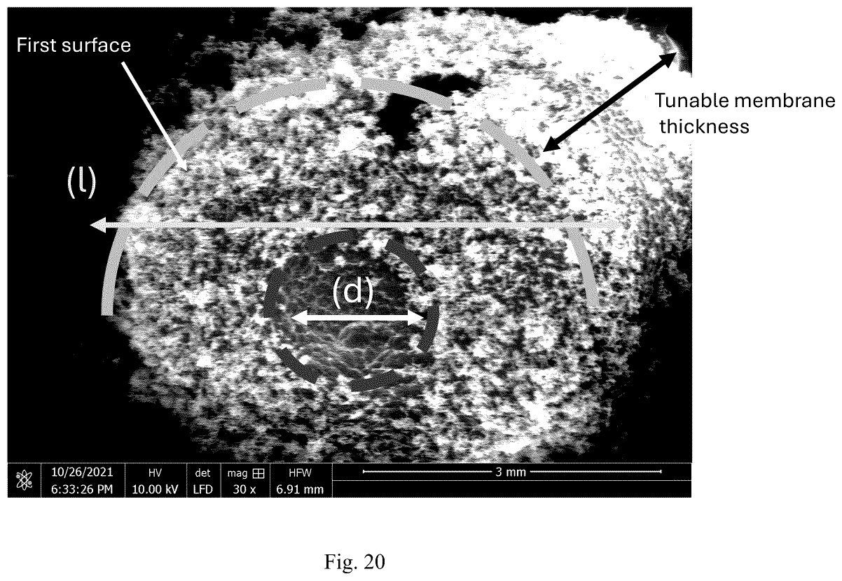

In some embodiments, the membrane material can take the form of any three-dimensional shape, including, but not limited to, a cylinder, a sheet, a cone, a prism, a rectangle, a cube, a random or custom shape, and the like. In some embodiments, as shown in FIG. 20, the membrane material forms a cylinder, with the at least one channel passing through the length of the cylinder. In some embodiments, as shown in FIG. 20, the cylinder-shaped membrane material would also have a first surface, a second surface, and a tunable membrane thickness. In some embodiments, the membrane material forms a sheet with the at least one channel passing through the thickness of the sheet. In some embodiments, the membrane material is in the form of a cylinder, wherein the cylinder has an outer diameter with a length (l) (FIG. 20). As such, the term “cylinder” is meant to refer to the membrane material when in the form of a cylinder. In some embodiments, the outer diameter is the same length across the thickness of the cylinder. In some embodiments, the length of the outer diameter gradually decreases towards the first surface of the cylinder. In some embodiments, the length of the outer diameter gradually decreases towards the second surface of the cylinder. In some embodiments, the length of the outer diameter gradually increases in length towards the first surface of the cylinder and gradually decreases in length towards the second surface of the cylinder. In some embodiments, the diameter of the channel (d) increases or decreases or both, in response to a change in the outer diameter of the cylinder.

As discussed herein, the terms “pore” and “channel” may be used interchangeably in reference to a passage that extends through a thickness of the membrane material, either fully through the thickness from one side to the other, or into the depth of the membrane material but not all the way through, similar to a recess. Therefore, the terms “channel” and “pore” can be used interchangeably herein and all description of a pore or a channel can thus refer to each other and are applicable to each other.

In some embodiments, the membrane material surfaces within the pore may comprise a coating having any of the materials described for the membrane material, including but not limited to, metals, minerals, solvents, polymers, inorganic materials, graphene oxide, activated carbon, two-dimensional materials, plasma, bacterial cultures, water, chitosan, carbon nanotubes, graphite, etc.

In some embodiments, the pore has a diameter of less than 100 millimeters (mm). In some embodiments, the pore has a diameter of less than 10 mm. In some embodiments, the pore has a diameter of less than 9 mm. In some embodiments, the pore has a diameter of less than 8 mm. In some embodiments, the pore has a diameter of less than 7 mm. In some embodiments, the pore has a diameter of less than 6 mm. In some embodiments, the pore has a diameter of less than 5 mm. In some embodiments, the pore has a diameter of less than 4 mm. In some embodiments, the pore has a diameter of less than 3 mm. In some embodiments, the pore has a diameter of less than 2 mm. In some embodiments, the pore has a diameter of less than 1 mm.

In some embodiments, the pore has a diameter of less than 900 micrometers (μm). In some embodiments, the pore has a diameter of less than 800 μm. In some embodiments, the pore has a diameter of less than 700 μm. In some embodiments, the pore has a diameter of less than 600 μm. In some embodiments, the pore has a diameter of less than 500 μm. In some embodiments, the pore has a diameter of less than 400 μm. In some embodiments, the pore has a diameter of less than 300 μm. In some embodiments, the pore has a diameter of less than 200 μm. In some embodiments, the pore has a diameter of less than 100 μm. In some embodiments, the pore has a diameter of less than 50 μm. In some embodiments, the pore has a diameter of less than 1 μm.

In some embodiments, the pore has a diameter of less than 900 nanometers (nm). In some embodiments, the pore has a diameter of less than 800 nm. In some embodiments, the pore has a diameter of less than 700 nm. In some embodiments, the pore has a diameter of less than 600 nm. In some embodiments, the pore has a diameter of less than 500 nm. In some embodiments, the pore has a diameter of less than 400 nm. In some embodiments, the pore has a diameter of less than 300 nm. In some embodiments, the pore has a diameter of less than 200 nm. In some embodiments, the pore has a diameter of less than 100 nm. In some embodiments, the pore has a diameter of less than 50 nm. In some embodiments, the pore has a diameter of less than 40 nm. In some embodiments, the pore has a diameter of less than 30 nm. In some embodiments, the pore has a diameter of less than 20 nm. In some embodiments, the pore has a diameter of less than 10 nm. In some embodiments, the pore has a diameter of less than 9 nm. In some embodiments, the pore has a diameter of less than 8 nm. In some embodiments, the pore has a diameter of less than 7 nm. In some embodiments, the pore has a diameter of less than 6 nm. In some embodiments, the pore has a diameter of less than 5 nm. In some embodiments, the pore has a diameter of less than 4 nm. In some embodiments, the pore has a diameter of less than 3 nm. In some embodiments, the pore has a diameter of less than 2 nm. In some embodiments, the pore has a diameter of less than 1 nm.

In some embodiments, the pore has a diameter of about 50 nm. In some embodiments, the pore has a diameter of about 25 nm. In some embodiments, the pore has a diameter of about 8 nm. In some embodiments, the pore has a diameter of about 15 nm. In some embodiments, the pore has a diameter of about 10 nm. In some embodiments, the pore has a diameter of about 9 nm. In some embodiments, the pore has a diameter of about 8 nm. In some embodiments, the pore has a diameter of about 7 nm. In some embodiments, the pore has a diameter of about 6 nm. In some embodiments, the pore has a diameter of about 5 nm. In some embodiments, the pore has a diameter of about 4 nm. In some embodiments, the pore has a diameter of about 3 nm. In some embodiments, the pore has a diameter of about 2 nm. In some embodiments, the pore has a diameter of about 4 nm. In some embodiments, the pore has a diameter of about 1 nm.

In some embodiments, the outer diameter of the cylinder has a length of less than 100 millimeters (mm). In some embodiments, the outer diameter of the cylinder has a length of less than 10 mm. In some embodiments, the outer diameter of the cylinder has a length of less than 9 mm. In some embodiments, the outer diameter of the cylinder has a length of less than 8 mm. In some embodiments, the outer diameter of the cylinder has a length of less than 7 mm. In some embodiments, the outer diameter of the cylinder has a length of less than 6 mm. In some embodiments, the outer diameter of the cylinder has a length of less than 5 mm. In some embodiments, the outer diameter of the cylinder has a length of less than 4 mm. In some embodiments, the outer diameter of the cylinder has a length of less than 3 mm. In some embodiments, the outer diameter of the cylinder has a length of less than 2 mm. In some embodiments, the outer diameter of the cylinder has a length of less than 1 mm.

In some embodiments, the outer diameter of the cylinder has a length of less than 900 micrometers (μm). In some embodiments, the outer diameter of the cylinder has a length of less than 800 μm. In some embodiments, the outer diameter of the cylinder has a length of less than 700 μm. In some embodiments, the outer diameter of the cylinder has a length of less than 600 μm. In some embodiments, the outer diameter of the cylinder has a length of less than 500 μm. In some embodiments, the outer diameter of the cylinder has a length of less than 400 μm. In some embodiments, the outer diameter of the cylinder has a length of less than 300 μm. In some embodiments, the outer diameter of the cylinder has a length of less than 200 μm. In some embodiments, the outer diameter of the cylinder has a length of less than 100 μm. In some embodiments, the cylinder has an outer diameter of less than 50 μm. In some embodiments, the outer diameter of the cylinder has a length of less than 1 μm.

In some embodiments, the outer diameter of the cylinder has a length of less than 900 nanometers (nm). In some embodiments, the outer diameter of the cylinder has a length of less than 800 nm. In some embodiments, the outer diameter of the cylinder has a length of less than 700 nm. In some embodiments, the outer diameter of the cylinder has a length of less than 600 nm. In some embodiments, the outer diameter of the cylinder has a length of less than 500 nm. In some embodiments, the outer diameter of the cylinder has a length of less than 400 nm. In some embodiments, the outer diameter of the cylinder has a length of less than 300 nm. In some embodiments, the outer diameter of the cylinder has a length of less than 200 nm. In some embodiments, the outer diameter of the cylinder has a length of less than 100 nm. In some embodiments, the outer diameter of the cylinder has a length of less than 50 nm. In some embodiments, the outer diameter of the cylinder has a length of less than 40 nm. In some embodiments, the outer diameter of the cylinder has a length of less than 30 nm. In some embodiments, the outer diameter of the cylinder has a length of less than 20 nm. In some embodiments, the outer diameter of the cylinder has a length of less than 10 nm. In some embodiments, the outer diameter of the cylinder has a length of less than 9 nm. In some embodiments, the outer diameter of the cylinder has a length of less than 8 nm. In some embodiments, the outer diameter of the cylinder has a length of less than 7 nm. In some embodiments, the outer diameter of the cylinder has a length of less than 6 nm. In some embodiments, the outer diameter of the cylinder has a length of less than 5 nm. In some embodiments, the outer diameter of the cylinder has a length of less than 4 nm. In some embodiments, the outer diameter of the cylinder has a length of less than 3 nm. In some embodiments, the outer diameter of the cylinder has a length of less than 2 nm.

Exemplary polymers forming at least part of the membrane material include, but are not limited to, polyethylene glycol; polypropylene glycol; polylactic acid; polyvinyl methyl ether; polyvinyl ethyl ether; polyvinyl alcohol; polyvinyl esters such as polyvinyl acetate and poly (vinyl cinnamate); polyvinylpyrrolidone; polyacrylics and polyacrylates such as polyhydroxypropyl acrylate, poly (methyl acrylate), poly (methyl methacrylate), polyacrylic acid;

polyesters such as polyglycolide, polyglycolic acid, polylactic acid, polycaprolactone, polyhydroxy-alkanoate, polyhydroxybutyrate, polyethylene adipate, polybutylene succinate, poly (3-hydroxybutyrate-co-3-hydroxyvalerate), polyethylene terephthalate, polybutylene terephthalate, polytrimethylene terephthalate, polyethylene naphthalate, and Vectran™; cellulose; unsaturated polyesters; methyl cellulose; hydroxyethyl cellulose; hydroxypropyl methyl cellulose; hydroxypropyl cellulose; ethyl hydroxyethyl cellulose; hydrophobically-modified cellulose; epoxy resins such as aromatic epoxy resins, aliphatic epoxy resins, alicyclic epoxy resins, and heterocyclic epoxy resins; more specific examples of the epoxy resins include bisphenol A-type epoxy resins, bisphenol F-type epoxy resins, bisphenol AD-type epoxy resins, fluorine-containing epoxy resins, triglycidyl isocyanurate, alicyclic glycidyl ether-type epoxy resins, alicyclic glycidyl ester-type epoxy resins, and novolac-type epoxy resins; triacetate polymers such as cellulose triacetate; dextran; hydrophobically-modified dextran; agarose; low-gelling-temperature agarose; latex; pectin; polyvinyl chloride; polypropylene; polyethylene; polystyrene; styrene-butadiene copolymer; acrylonitrile butadiene styrene (ABS); poly (ethylenimine); polycarbonate; polyetherimide; poly (ethylene glycol) (N) monomethacrylate; methylmethacrylate; poly (ethylene glycol) (N) monomethyl ether monomethacrylate; nylon; nylon 6; nylon 6,6; chitosan; rayon; polytetrafluoroethylene (Teflon/PTFE); expanded polytetrafluoroethylene (e-PTFE), thermoplastic polyurethanes; polyacrylamides; polyacrylonitriles; polysulfones such as polysulfone, polyethersulfone, and polyphenylsulfone; and combinations thereof.

In one embodiment, the organic polymer forming at least part of the membrane material comprises a natural polymer such as, but not limited to, cellulose, chitosan, albumin-and albumin-like polymeric composites, heparin and heparin-like composites, carrageenan, alginate, collagen, guar gum, agarose, carboxymethyl cellulose, hydroxyethyl cellulose, dextran, hyaluronic acid, pectin, alginic acid, agar, xanthan, collagen-glycosaminoglycan, collagen, pullulan, mannan, lignans such as Kraft lignin, lignosulfonate, alkali lignin, low sulfonate alkali lignin, Klason lignin, and acid hydrolysis lignin, and combinations thereof.

In one embodiment, the polymer includes one or more crosslinkers. Exemplary crosslinkers include glutaraldehyde, epichlorohydrin, sulfuric acid, hexamethylene diisocyante, aldehyde-dextran, aldehyde-pectin, aldehyde-starch, tripolyphosphate, 1,3,5-benzene tricarboxylic acid, terepthaladehdyde, genipin, carbodiimides, melamines, epoxides, isocyanates, aziridine, silanes, aziridines, polycarbodiimides, metal chelates, di-to poly-functional acrylates, trimethylolpropane, 1,2,6-hexanetriol, triethanol amine, polyphosphazene, glycoluril, benzoguanamine, urea, dihydrazides, diazides, divinylbenzene, polyamines such as triethylenetetraamine, polyamides, diacyl chlorides, dianhydrides, and combinations thereof.

In one embodiment, the membrane material further comprises a dispersant. In one embodiment, the dispersant is a surfactant. The surfactant is not particularly limited, and is, for example, an anionic surfactant, a cationic surfactant, a nonionic surfactant, or a block copolymer composed of a hydrophilic block and a hydrophobic block, such as, for example, a block copolymer composed of a polyacrylic acid block and a polyacrylic ester block, a block copolymer composed of a polyoxyethylene block and a polyacrylic ester block, or a block copolymer composed of a polyoxyethylene block and a polyoxypropylene block. In one embodiment, the composition comprises a polysorbate surfactant. Exemplary polysorbate surfactants include Polysorbate 20, Polysorbate 40, Polysorbate 60, Polysorbate 65, Polysorbate 80, and Polysorbate 85.

Exemplary anionic surfactants include fatty acid salts, sulfuric ester salts of higher alcohols, phosphoric ester salts of fatty alcohols, alkyl aryl sulfonate, and formalin condensates of naphthalene sulfonic acid salts. Exemplary cationic surfactants include alkyl primary amine salts, alkyl secondary amine salts, alkyl tertiary amine salts, alkyl quaternary ammonium salts, and pyridinium salts. Exemplary nonionic surfactants include polyoxyethylene alkyl ethers, polyoxyethylene alkyl phenylethers, polyoxyethylene alkyl esters, sorbitan alkyl esters, and polyoxyethylene sorbitan alkyl esters. Exemplary high molecular weight surfactants include partially-saponified polyvinyl alcohols, polyvinylpyrrolidone, starch, methylcellulose, carboxymethyl cellulose, hydroxyethyl cellulose, and partially-saponified polymatacrylic acid salts.

### Membrane Systems

Aspects of the present invention relate to membrane systems configured for purification and/or filtration comprising the membrane material disclosed in this application. In some embodiments, the present invention relates to a system comprising a first chamber and a second chamber, wherein a membrane material is positioned between the first chamber and the second chamber and configured to permit a fluid to pass from the first chamber into the second chamber through the membrane material. Exemplary systems include any system described herein, as well as other systems such as those described in U.S. Pat. No. 12,161,975 and International Patent Publication No. WO2024050003, the entire contents of which are each incorporated herein by reference as if set forth in their entirety. The systems may also include a power supply, and at least one magnet electrically connected to the power supply, the at least one magnet or magnetic material configured to generate a magnetic field, wherein the at least one magnet or magnetic material is positioned adjacent to the membrane material such that at least a portion of the membrane material resides within the generated magnetic field. In some embodiments, the system comprises at least one antenna electrically connected to the power supply and configured to generate a radio frequency, wherein the at least one antenna is positioned adjacent to the membrane material such that at least a portion of the membrane material resides within the radio frequency range. In some embodiments, the system comprises both an antenna and a magnet electrically connected to the power supply, as described above. In other embodiments, the system includes an electrode connected to the power supply, where the electrode is configured to generate electrical stimulus capable of modulating the size, shape, surface charge, tortuosity, or combinations thereof of the membrane material and the size, shape, surface charge, tortuosity, or combinations thereof of the one or more pores or channels in a similar manner as described herein for a magnetic or electromagnetic field.

In some embodiments, the membrane material is configured to change in size, shape, surface charge, tortuosity, or combinations thereof, in response to the generated magnetic field, radio frequency, or electrical stimulus from one or more electronde. In some embodiments, the change in the membrane material comprises a change in size, shape, surface charge, tortuosity, or combinations thereof, of the at least one channel. In some embodiments, the change in the membrane material responsive to the generated magnetic field, radio frequency, or electrical stimulus from one or more electronde comprises an increased diameter of the at least one channel. In some embodiments, the change in the membrane material responsive to the generated magnetic field, radio frequency, or electrical stimulus from one or more electrodes comprises a decreased diameter of the at least one channel. In some embodiments, the change in the membrane material responsive to the generated magnetic field, radio frequency, or electrical stimulus from one or more electrodes comprises a gradual increase in diameter of the at least one channel towards the first surface of the membrane material. In some embodiments, the change in the membrane material responsive to the generated magnetic field, radio frequency, or electrical stimulus from one or more electrodes comprises a gradual decrease in diameter of the at least one channel towards the second surface of the membrane material. In some embodiments, the change in the membrane material responsive to the generated magnetic field, radio frequency, or electrical stimulus from one or more electrodes comprises a gradual increase in diameter of the at least one channel towards the first surface of the membrane material and a gradual decrease in diameter of the at least one channel towards the second surface of the membrane material.

In some embodiments, the at least one channel comprises at least two channels, wherein the change in the membrane material responsive to the generated magnetic field, radio frequency, or electrical stimulus from one or more electrodes comprises a first change in diameter of a first channel and a second change in diameter of a second channel, wherein the first and second changes in diameter are different. In some embodiments, the at least one magnet is a magnetic coil. In some embodiments, the power supply is communicatively connected to a computing environment configured to control the generation of the magnetic field, radio frequency, or electrical stimulus from one or more electrodes via the power supply. In some embodiments, the computing environment is controlled by an artificial intelligence unit. In some embodiments, the system further comprises at least one sensor communicatively connected to the computing environment, the at least one sensor configured to measure at least one parameter of the membrane material or system. In some embodiments, the artificial intelligence unit generates the change in the at least one channel based on the at least one parameter measured by the at least one sensor. In some embodiments, the system further comprises an electromagnetically shielding material or an electromagnetically responsive, or both.

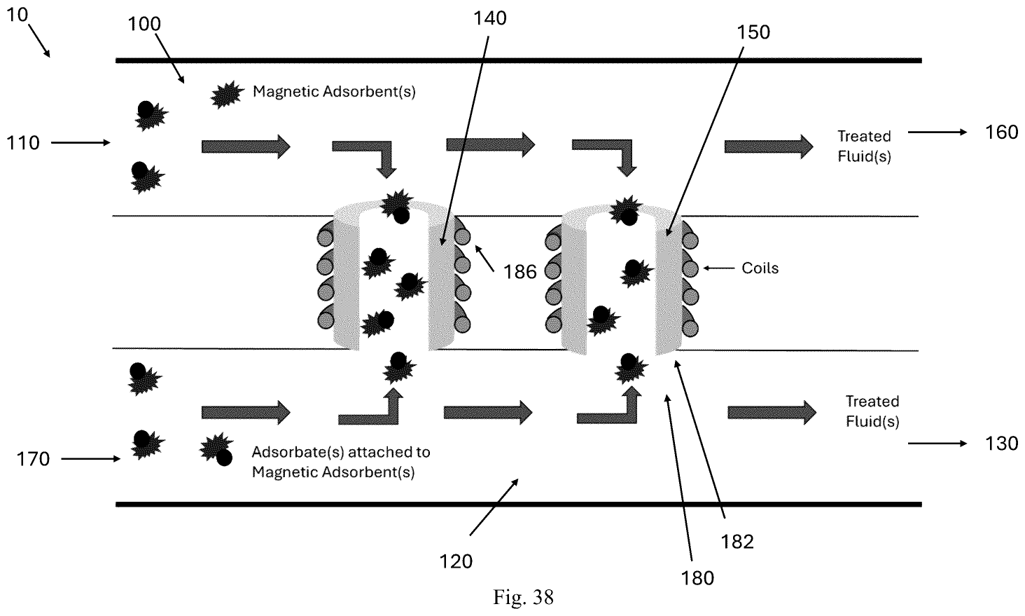

Referring now to FIGS. 38-42, shown are exemplary filtration systems (10), wherein in some embodiments the system of the present invention comprises at least one first chamber (100) with an input (110); at least one second chamber (120) with a an output (130); and at least one membrane material (140) comprising coils (186) (also referred to as “coiled membrane materials” herein); in some embodiments, the coils are magnetic coils; wherein the at least one membrane material (140) is positioned between the first and second chambers (100, 120) and configured to permit fluid to pass from the first chamber (100) through the at least one membrane material (140), into the second chamber (120), and out the second output (130). In some embodiments, the coils may alternatively be an electrode, where the electrode may provide electrical stimulus to effect a change to the membrane material. Accordingly, any coil may also be considered an electrode in the alternative. In some embodiments, the first chamber (100) comprises a first chamber output (160), and the second chamber (120) comprises a second chamber input (170). In some embodiments, filtration system (10) comprises at least one sensor (200) configured to measure various parameters of the system (10). For example, in some embodiments, at least one sensor 200 is positioned within the at least one first chamber (100) and/or within the at least one second chamber (120). In some embodiments, the at least one sensor (200) comprises an electrode in fluid communication with at least one of the chambers, or positioned within or on the at least one membrane material. In some embodiments, the at least one sensor (200) comprises a sensory network, and/or one or more microelectrode arrays. In some embodiments, filtration system (10) may be electronically connected to a computing device (e.g., computer (1000)) and may be at least partially controlled by the computing device and/or one or more machine learning algorithms, artificial intelligence systems, and/or one or more neural networks operating thereon, as discussed further herein.

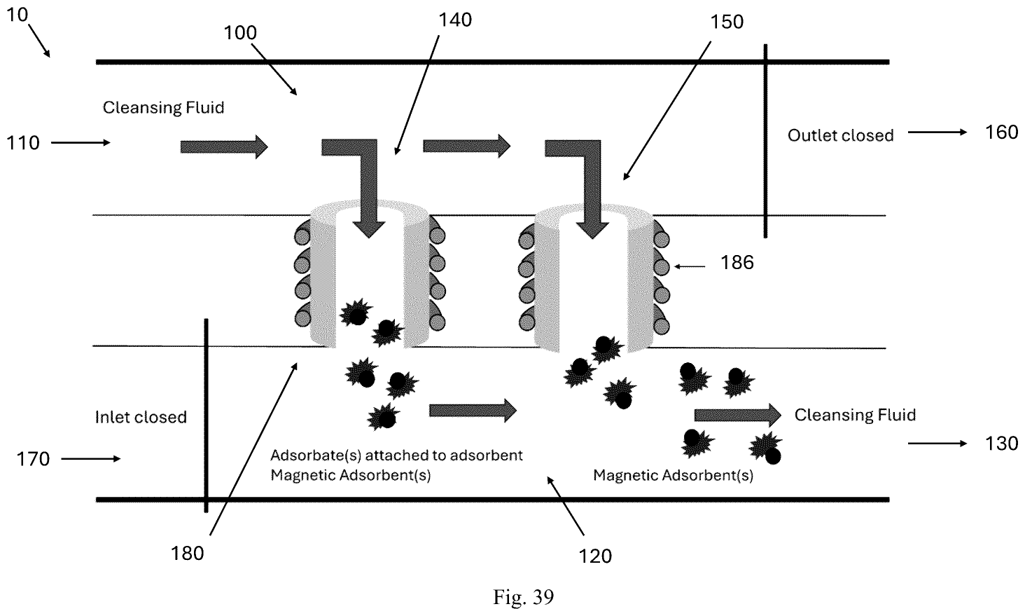

FIG. 38 shows a cross-section of an exemplary filtration system (10). Fluids enter the filtration system (10) as such that the adsorbates are readily adsorbed to magnetic adsorbents. In one embodiment, coiled membrane materials provide electromagnetic fields to capture the magnetic adsorbents over the separation phase and treated fluid(s) leave the membrane material without magnetic adsorbents. In some embodiments, magnetic adsorbents are collected in the membrane material. In this embodiment, the filtration system (10) runs until the membrane material becomes saturated. After saturation of the membrane material, electromagnetic fields are switched off to release and recycle the adsorbents as shown in FIG. 39, where electromagnetic fields are deactivated, and a cleansing fluid is pushed through the membrane material (140) to recover the magnetic adsorbents.

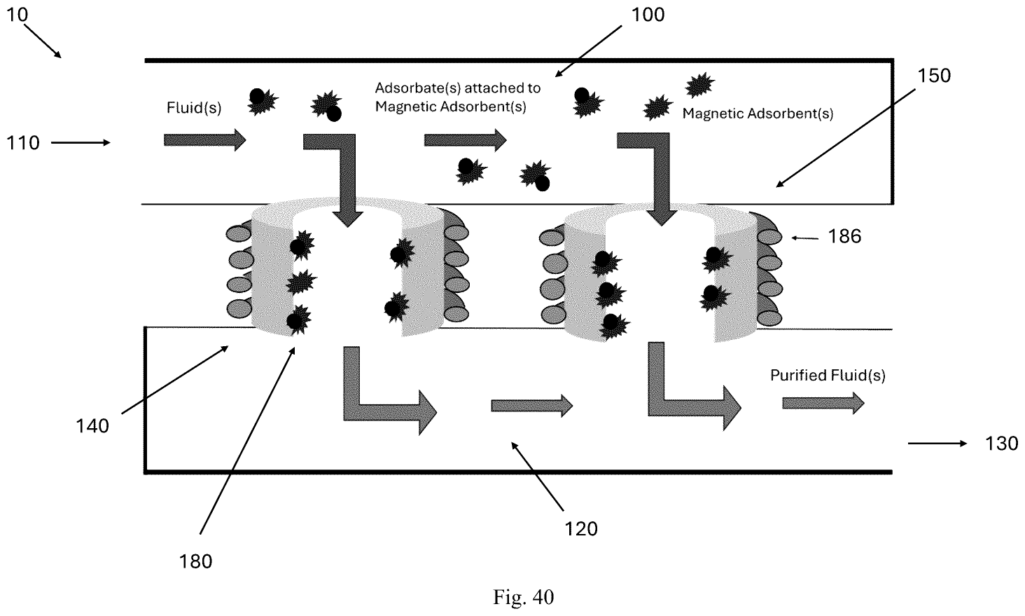

In some embodiments, the fluids containing magnetic adsorbents are pushed through the membrane material comprising coils where magnetic adsorbents are attracted to electromagnets and purified fluids leave the system (10) without the magnetic adsorbents as shown in FIG. 40. Once the membrane material is saturated the cleansing process is similar to the previously shown process as shown in FIG. 39. In the above-mentioned examples, pore geometry and dimensions simply remain the same throughout the processes or can be fine-tuned as explained here and elsewhere in this application. In some embodiments, electromagnetically tunable membrane materials may change their geometry, dimensions, surface charge, tortuosity, and combinations thereof, in response to locally applied electromagnetic fields, radio frequencies, or electrical stimulus from one or more electrodes. In some embodiments, the pores change in geometry, dimensions, surface charge, tortuosity, and combinations thereof, in response to the change in the membrane materials.

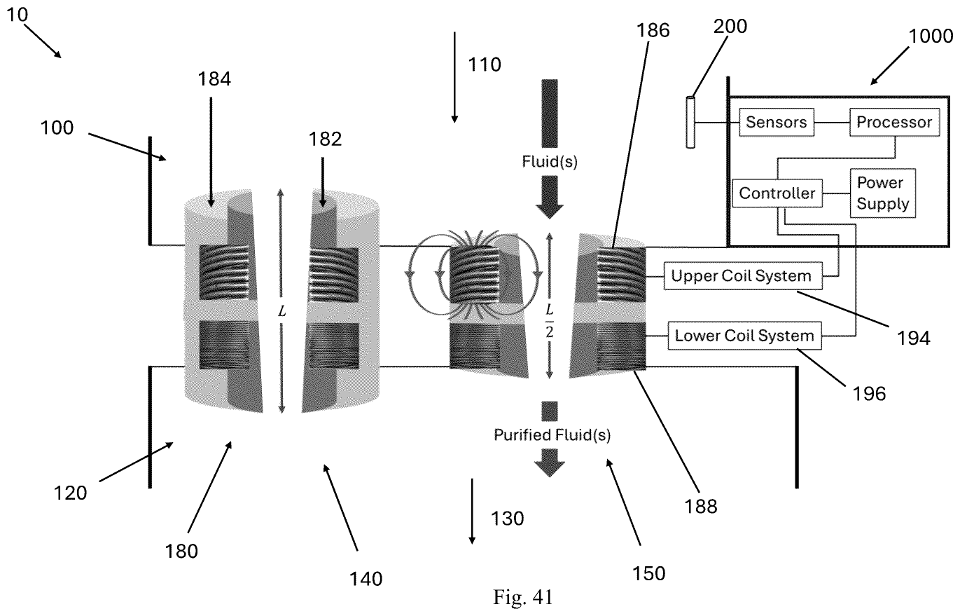

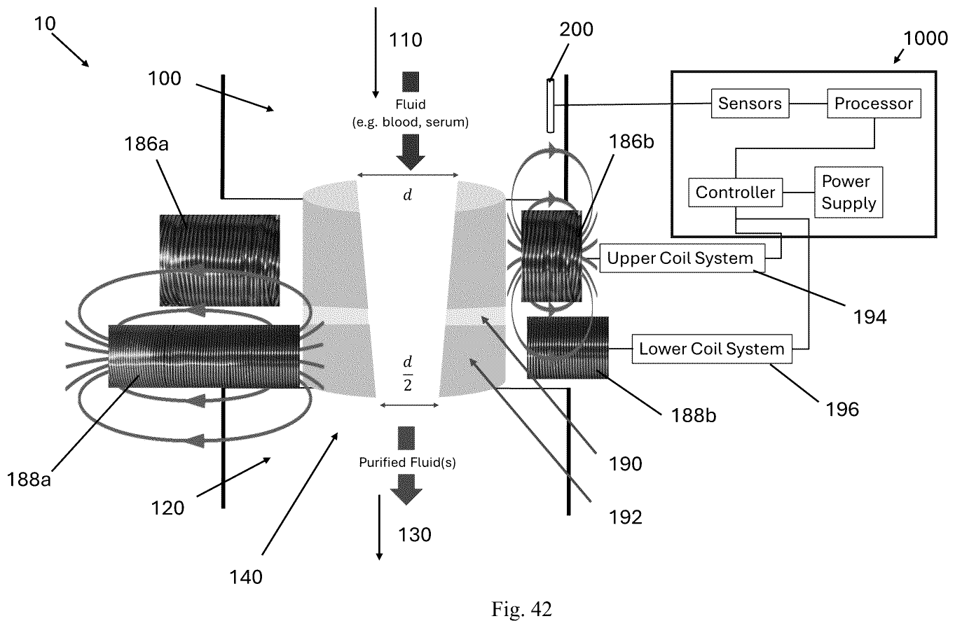

In some embodiments, the coiled membrane materials have multiple layers and segments of electromagnetically and radio frequency responsive materials where vertically oriented coils are switched on and off. In some embodiments, voltages and currents are adjusted as such that the length of the membrane materials comprising coils are altered in response to locally exerted magnetic, electromagnetic fields or forces or radio frequencies. The use of electromagnetic and radio frequency (RF) shielding materials in combination with electromagnetic or RF responsive materials allow the local application of magnetic, electromagnetic, and radio frequency fields and forces. A simplified example of system (10) comprising a vertically oriented coil system embedded in coiled membrane materials is depicted in FIG. 41. In some embodiments, sensors (e.g., sensor 200) continuously measure parameters, including but not limited to, analytes in the fluids, in the membrane materials, and/or in the environmental and operations conditions, and the collected data is provided to a processor (e.g., GPU/CPU of computer 1000). With the use of advanced artificial intelligence (AI) systems discussed further herein, parameters such as voltages and currents are calculated, and signals are sent to a controller to regulate current and voltages in the coils (186) producing precise electromagnetic fields, or to electrodes that produce electrical stimulus, such that membrane materials are finely tuned to yield the optimal operational conditions for the membrane materials. In some embodiments, the electromagnetic fields or electrical stimulus change the size, shape, surface charge, tortuosity, or combinations thereof, of the membrane materials comprising coils. In some embodiments, the electromagnetic fields or electrical stimulus change the size, shape, surface charge, tortuosity, or combinations thereof, of the at least one channel in the membrane material comprising coils. The changes in the membrane material and at least one channel include changes to the diameters as described elsewhere in this application. Also, as shown in FIG. 41, coil densities can vary in each section depending on the electromagnetic forces needed. In some embodiments, the coiled membrane materials comprise multiple layers and segments made from materials responsive to electromagnetic and radio frequencies. Horizontally oriented coils are employed to modify the inner dimensions, geometry, and tortuosity of the pores, as shown in FIG. 42.

In some embodiments, the coiled membrane material comprises, or is formed from, an electromagnetic responsive material (182). In some embodiments, the electromagnetic responsive material (182) is at least partially surrounded by an electromagnetic shield elastomer (184). In some embodiments, the coiled membrane material comprises one or more coils (186). In some embodiments, the coils comprise at least one upper coil (186a/186b) and at least one lower coil (188a/188b). In some embodiments, the at least one upper coil is connected to an upper coil system (194), and the at least one lower coil is connected to a lower coil system (196), all of which is electronically connected to a computing device (e.g., computer (1000)) for power and control. In some embodiments, the at least one upper coil comprises at least a first upper coil (186a) and a second upper coil (186b), and the at least one lower coil comprises at least a first lower coil (188a) and a second upper coil (188b). In some embodiments, the electromagnetic shield elastomer (184) comprises at least one portion of electromagnetic shield materials (190) at least partially surrounded by at least one portion of electromagnetic responsive materials (192).

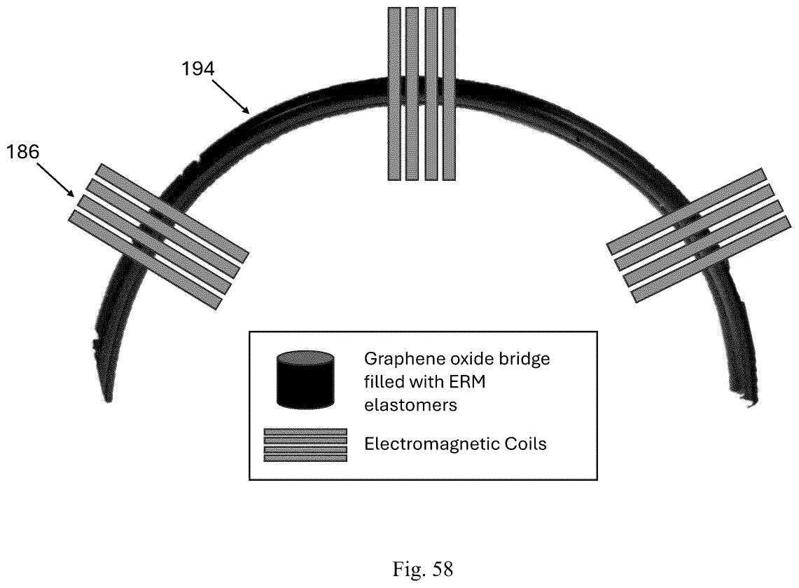

In some embodiments, as shown in FIG. 58, a housing unit such as a tube (194) is filled with electromagnetic responsive materials and/or other materials such as graphene oxide. In some embodiments, the housing unit is filled with the membrane materials described herein. In some embodiments, the housing unit comprises at least one coil (186). In some embodiments, the at least one coil is electronically connected to a computing device for power and control. In some embodiments, the external stimuli described elsewhere herein is used to control the flow of fluids, ions, salts, and combinations thereof in the tubes. Exemplary housing units include, but are not limited to, tubes, capillary tubes, microplates, u-shaped tubes, peristaltic pump tubes, two-ended glass tubes, dual-port tubing.

Exemplary electromagnetic shielding materials include, but are not limited to, conductive silicone rubbers, carbon-black filled rubbers, silver-coated rubbers, graphene-based rubbers, metal-loaded rubbers, thermoplastic elastomers with conductive fillers, polyurethane elastomers with conductive carbon, natural rubber with conductive fillers, and combinations thereof. Electromagnetic responsive materials include, but are not limited to piezoelectric materials, ferromagnetic particles, conductive polymers, photonic crystals, graphene, magnetic materials, magnetic minerals, rare-earth elements, superconducting materials, plasmonic materials, and the like. In some embodiments, the electromagnetically shielding material is an electromagnetically shielding elastomer know in the art.

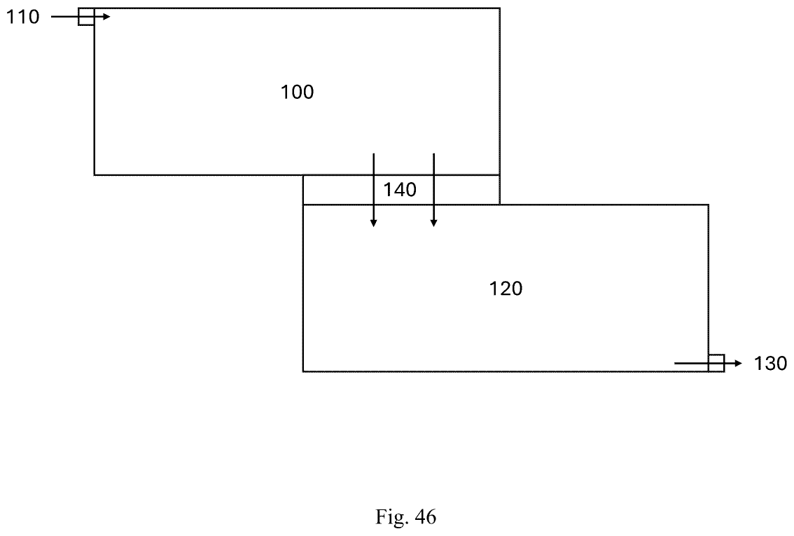

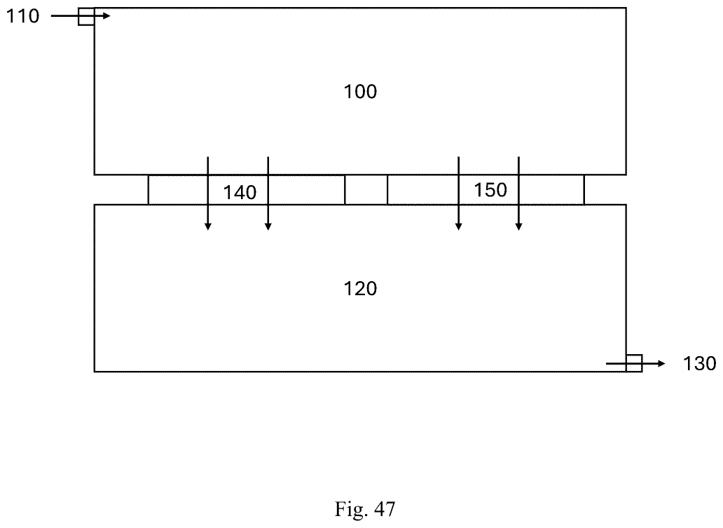

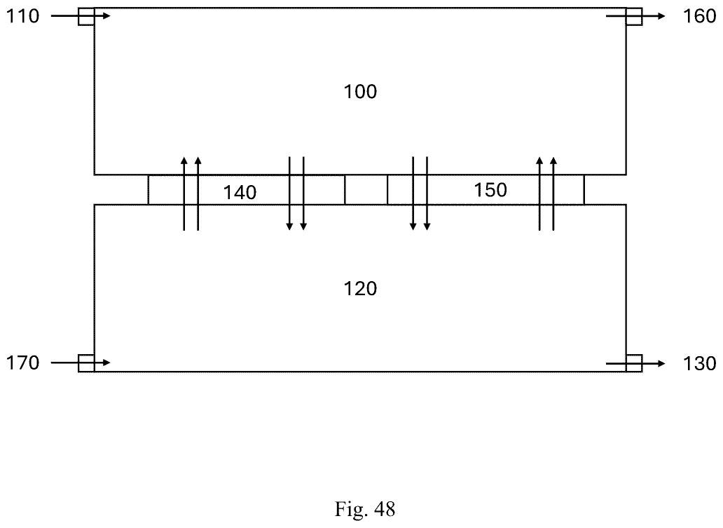

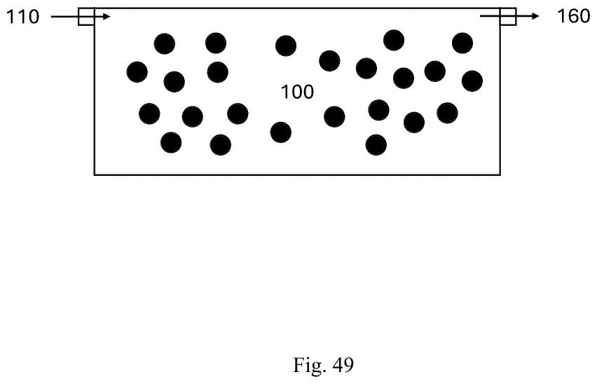

In some embodiments, the present invention relates to purification system comprising the membrane material described herein. In some embodiments, as shown in FIG. 46, the purification or filtration system (10) comprises at least one first chamber (100) with an input (110); at least one second chamber (120) with a an output (130); at least one membrane material (140); wherein the membrane material is positioned between the first and second chambers and configured to allow fluid to flow from the first chamber through the membrane material, into the second chamber, and out the second output. The arrows in FIG. 46, FIG. 47, FIG. 48, and FIG. 49 are representative of the direction of fluid flow.

In some embodiments, the purification or filtration system (10) comprises more than one membrane material positioned between the first chamber and the second chamber, as shown in FIG. 47. In one embodiment, the purification or filtration system (10) comprises a first membrane material and a second membrane material (150) downstream from the first membrane material and configured to allow fluid to flow from the first chamber, through the second membrane material and into the second chamber, and out the second chamber output; additionally, the first membrane material may behave like the membrane material in the system in FIG. 46.

In some embodiments, the first chamber comprises a first chamber output (160) and the second chamber comprises a second chamber input (170), as shown in FIG. 48; wherein a first and second membrane material are configured to allow fluid to flow from the first chamber, through the first membrane material and into the second chamber, through the second membrane material and into the first chamber, and out the first chamber output; or alternatively, or simultaneously, fluid can flow from the second chamber, through the first membrane material and into the first chamber, through the second membrane material and into the second chamber, and out the second chamber output. The membrane materials can be configured in any way (series, parallel, stacked) to achieve maximum purification of the fluid.

In some embodiments, as shown in FIG. 49, the system comprises a first chamber (100) with a first chamber input and a first chamber output, wherein membrane material is configured throughout the first chamber (dots), such that fluid passes through the first chamber input, comes into contact with the membrane material, and out the first chamber output.

As mentioned above, the membrane materials of the system comprise coils connected to a power supply. In some embodiments, membrane materials do not comprise coils. In some embodiments, the coils are made of metal. In some embodiments, the power supply comprises a sensor, processor, controller, and combinations thereof. In some embodiments, the membrane materials and metal coils are configured such the metal coils run through the membrane materials and never come into contact with the fluid being purified. In some embodiments, the membrane materials are encased in a vessel and the metal coils surround the exterior of the vessel, wherein the coils never come into contact with either the membrane materials or the fluid being purified. In some embodiments, the metal coils are on the exterior surface of the chamber housing the membrane materials. In some embodiments, the metal coils are electromagnetic. Suitable materials for electromagnetic coils include but are not limited to copper, aluminum, silver, iron, nickel, metal alloys, and combinations thereof. In some embodiments, the metal coils are arranged vertically or horizontally amongst the membrane materials.

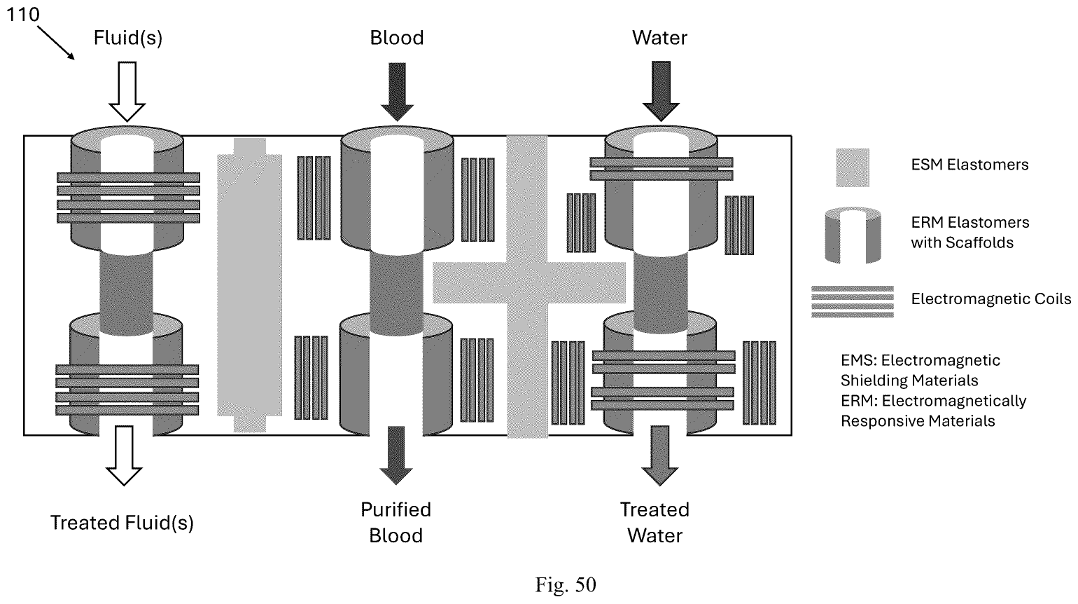

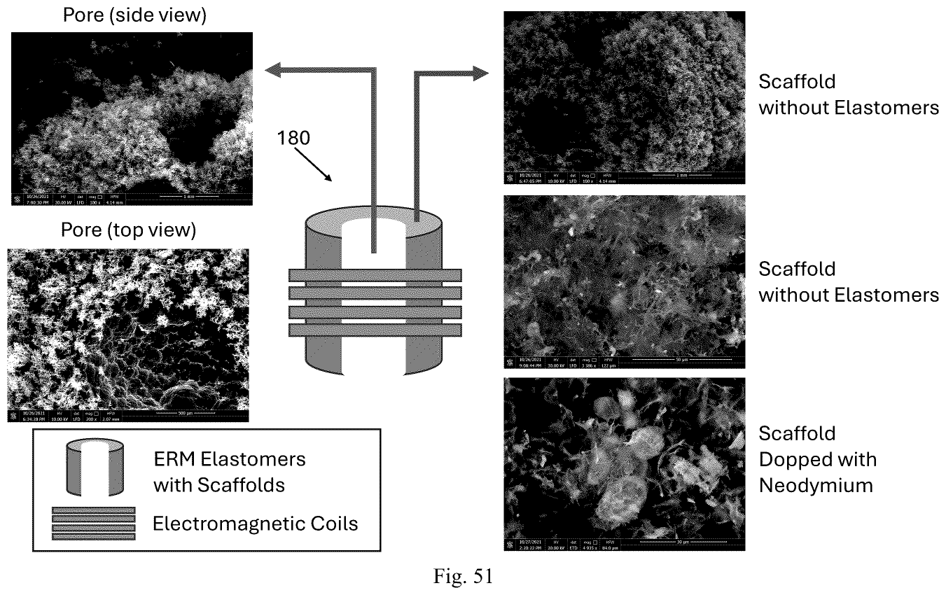

Referring now to FIG. 50 and FIG. 51, shown is an exemplary system with at least one membrane (110) comprising a plurality of coiled membrane materials wherein electromagnetic shielding materials (ESM) and/or ESM elastomers are positioned between each of the coiled membrane materials, and the coiled membrane materials comprise portions of electromagnetic responsive materials (ERMs) and/or ERM elastomers with scaffolds.

In some embodiments, the computing device (e.g., computer 1000) comprises at least one power supply, sensors (e.g., sensor 200), processors, controllers, and combinations thereof. In some embodiments the sensors are capable of detecting changes in pH, conductivity, pressure, humidity, gas concentrations, velocity of fluids and particulates, magnetic fields, temperature, concentration of specific salts, ions, and molecules, and combinations thereof. Suitable sensors include but are not limited to, glass electrode pH sensors, ion-sensitive field-effect transistor sensors, calorimetric sensors, optical sensors (absorbance/transmittance), conductivity sensors, refractometers, near-infrared sensors, resistance temperature detectors, thermocouples, thermistors, infrared sensors, multi-parameter probes, wireless sensors, photoionization detectors, flame ionization detectors, and combinations thereof. In some embodiments, the power supply is connected to a computing system (e.g., computer 1000 described herein) for control and programming.

Suitable controllers include, but are not limited to proportional-integral-derivative controllers, programmable logic controllers, distributed control systems, supervisory control and data acquisition) systems, and the like.

In some embodiments, computer 1000 comprises the components necessary to enable artificial intelligence and/or machine learning, including but not limited to, one or more neural networks with one or more models operating thereon.

### Artificial Intelligence

By incorporating a sensory network into the membrane separation unit described herein, and further incoporating a feedback loop between the sensory network and an artificial intelligence (AI) controlled unit operation, the membranes' surface charges, pore sizes, and pore shapes can change in response to data collected from environmental parameters such as pH, temperature, salinity/conductivity, and ion-specific concentration. This can help selectivetly target adsorption, desorption, or transport of ions and molecules. The AI-controlled unit is expected to be self-healing, self-cleaning, and antifouling. The following are applications of the electromagnetically controlled pore system.

Hemodialysis: In some embodiments, a hemodialysis machines reads the electrolytes and other blood constituents in patients during hemodialysis treatment. Here, in one embodiment of the invention, important electrolytes such as potassium are measured in both arterial and venous lines through hemodialysis treatment. The measurement can also be applied to the measurement of albumin, urea, phosphate, and protein-bound uremic toxins (PBUTs) as well. The pores' dimensions, geometries, and surface charges change in response to the measurement of the above-mentioned blood constituents, and in response to other patients' characteristics such as weight, age, blood pressure, heartrate, body temperature, and other comorbidities. Disclosed in this application are systems and membranes where the pores can change geometry, dimension, and surface charges throughout the use in response to measurements of blood constituents. The clinical significance includes the use of AI-driven precision and personalized treatment for Dialysis Disequilibrium Syndrome (DDS), hyperkalemia, hyperphosphatemia, and hypoalbuminemia. In some embodiments, AI can finetune the membrane characteristics in response to patients' blood constituents throughout the treatment.

Water Treatment: In water treatment, numerous measurement devices are commercially available for the measurement of pH, temperature, ionic strength, redux potential, and specific ions, which may connect and operate with the disclosed system (10) and/or computer (1000). As vast amounts of data are available, AI tools may be used with the disclosed system (10) for water quality monitoring and treatment decision making. In some embodiments, the AI controlled pores change dimensions, geometry, and surface charges in response to measurement of analytes. For example, as pH or salinity changes, the pore size or the surface charge of the membranes can change accordingly in response to environmental conditions, and operational conditions are adjusted accordingly.

General Application: The disclosed system (10) can be used in various fields, such as water treatment, pharmaceutical-grade fluid purification, lanthanides separation and purification, blood and serum purification, and hemodialysis to name a few. It can also be used for separation of suspended particles such as sediments in water treatment, and more advanced purification modules can be used for separation of ions and cations. Recovery of strategic and critical elements from electronic waste will significantly benefit from membranes that actively respond to environmental and operational conditions and are capable of separating ions and cations at atomic and molecular levels.

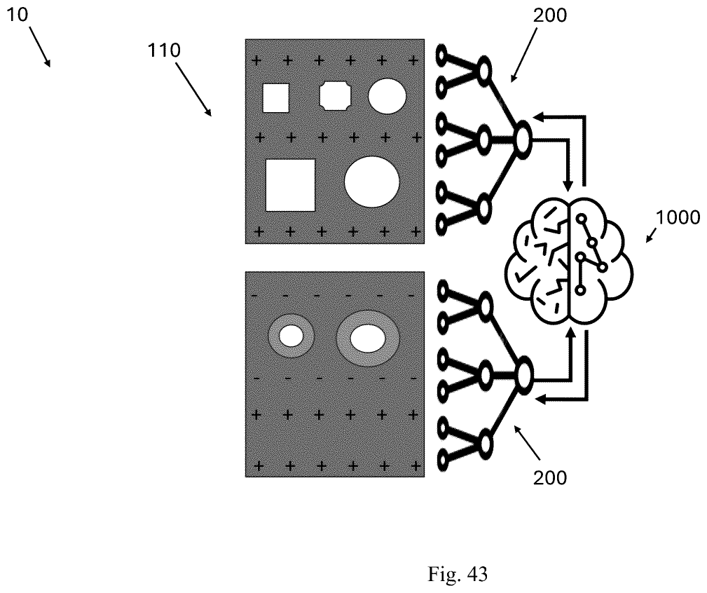

In some examples, the AI-driven bionic membranes described herein comprise a network of sensory grids (e.g., at least one sensor (200)) which convey environmental changes is pH, temperature, conductivity/salinity, and ion-specific concentrations (FIG. 43). Two examples include localized surface potential modulation and localized modulation via external magnetic fields.

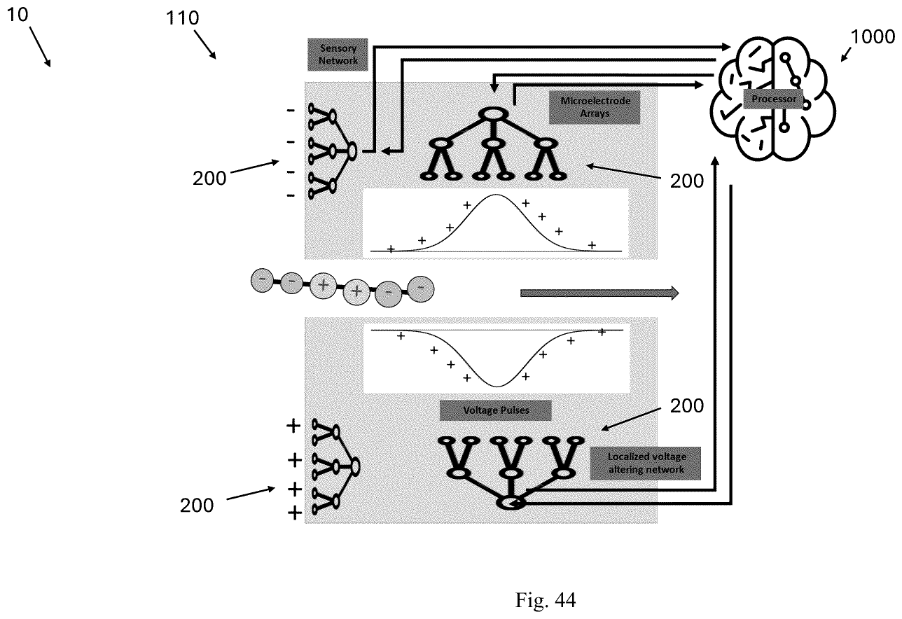

An AI-operated membrane design concept is further depicted in FIG. 44. A membrane cross-section with localized sensory systems and localized voltage adjustments (potential differences) is depicted. The AI-operated modular system can selectively capture or repel target molecules and ions. Electrical pulses generate charge variations throughout the pore to transport ions and molecules throughout the pore. The size and shape of the pores are changed locally by the alteration of voltages across the membrane. The hollow pores would mimic voltage-gated ion channels.

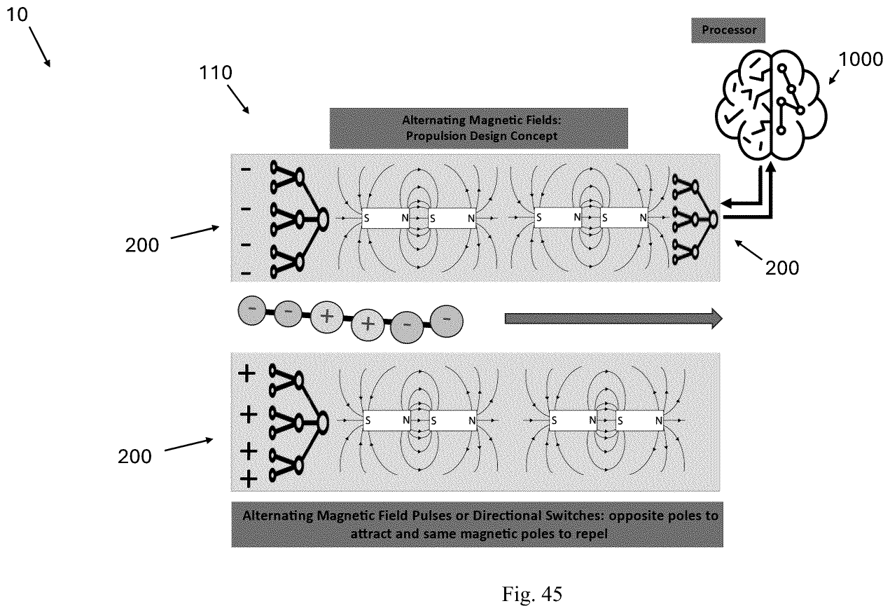

Another AI-operated membrane design concept is depicted in FIG. 45. A membrane cross-section with localized sensory systems and localized magnetic pulses is depicted. In this representation, magnetic fields alter the size and shape of pores. The membrane could be embedded with pores synthesized from hydrogels and aerogels, such as the ones described elsewhere herein, that respond to local alterations in external magnetic fields. Composites of metallic-neodymium and metallic-gadolinium hydrogels are used as pores or surface coatings to offer active transport of ions and molecules.

### Computing Environment

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

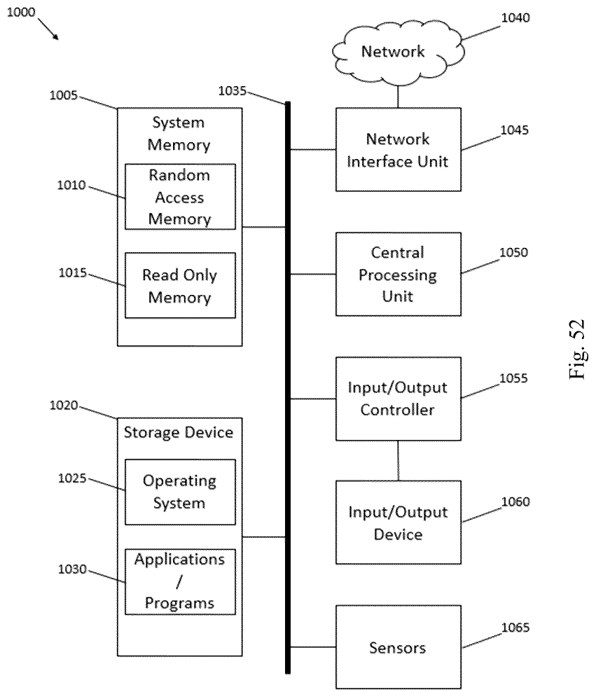

FIG. 52 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 52 depicts an illustrative computer architecture for a computer 1000 for practicing the various embodiments of the invention. The computer architecture shown in FIG. 52 illustrates a conventional personal computer, including a central processing unit 1050 (“CPU”), a system memory 1005, including a random-access memory 1010 (“RAM”) and a read-only memory (“ROM”) 1015, and a system bus 1035 that couples the system memory 1005 to the CPU 1050. A basic input/output system containing the basic routines that help to transfer information between elements within the computer, such as during startup, is stored in the ROM 1015. The computer 1000 further includes a storage device 1020 for storing an operating system 1025, application/program 1030, and data. In some embodiments, the computer 1000 further comprises one or more graphics processing units (GPUs) communicatively connected to the computer.

The storage device 1020 is connected to the CPU 1050 through a storage controller (not shown) connected to the bus 1035. The storage device 1020 and its associated computer-readable media, provide non-volatile storage for the computer 1000. Although the description of computer-readable media contained herein refers to a storage device, such as a hard disk or CD-ROM drive, it should be appreciated by those skilled in the art that computer-readable media can be any available media that can be accessed by the computer 1000.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 1000 may operate in a networked environment using logical connections to remote computers through a network 1040, such as TCP/IP network such as the Internet or an intranet. The computer 1000 may connect to the network 1040 through a network interface unit 1045 connected to the bus 1035. It should be appreciated that the network interface unit 1045 may also be utilized to connect to other types of networks and remote computer systems.

The computer 1000 may also include an input/output controller 1055 for receiving and processing input from a number of input/output devices 1060, including a keyboard, a mouse, a touchscreen, a camera, a microphone, a controller, a joystick, or other type of input device. Similarly, the input/output controller 1055 may provide output to a display screen, a printer, a speaker, or other type of output device. The computer 1000 can connect to the input/output device 1060 via a wired connection including, but not limited to, fiber optic, ethernet, or copper wire or wireless means including, but not limited to, Bluetooth, Near-Field Communication (NFC), infrared, or other suitable wired or wireless connections.

As mentioned briefly above, a number of program modules and data files may be stored in the storage device 1020 and RAM 1010 of the computer 1000, including an operating system 1025 suitable for controlling the operation of a networked computer. The storage device 1020 and RAM 1010 may also store one or more applications/programs 1030. In particular, the storage device 1020 and RAM 1010 may store an application/program 1030 for providing a variety of functionalities to a user. For instance, the application/program 1030 may comprise many types of programs such as a word processing application, a spreadsheet application, a desktop publishing application, a database application, a gaming application, internet browsing application, electronic mail application, messaging application, and the like. According to an embodiment of the present invention, the application/program 1030 comprises a multiple functionality software application for providing word processing functionality, slide presentation functionality, spreadsheet functionality, database functionality and the like.

The computer 1000 in some embodiments can include a variety of sensors 1065 for monitoring the environment surrounding and the environment internal to the computer 1000. These sensors 1065 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

### Method of Synthesizing Membrane Materials

In one aspect, the present invention related to a method of synthesizing the membrane material described herein, the method comprising the steps of: dispersing a mineral in a solvent to create a mixture and applying an external stimulus to the mixture to create the membrane material. In some embodiments, the step of dispersing a mineral in a solvent to create a mixture further comprises the step of adding a metal to the solvent. In some embodiments, the metal is a rare-earth metal. In some embodiments, the metal is from the lanthanide series. In one embodiment, the solvent is water. In one embodiment, the solvent is an aqueous solvent. In one embodiment, the solvent is an organic solvent. Exemplary, solvents, metals, minerals, and rare-earth metals are described elsewhere herein.

In some embodiments, the step of applying an external stimulus creates at least one pore within the membrane material. The size, shape, and features of the pore are described elsewhere herein. In some embodiments, the external stimulus is a magnetic field, a radiofrequency, an electric current, and combinations thereof. In some embodiments, the magnetic field is an external magnetic field. In some embodiments, the step of applying an external magnetic field is done with a magnet. In some embodiments, the external magnetic field is an electromagnetic field. In some embodiments, the step of applying an electromagnetic field to the mixture is done by applying an electric current to a coil which creates the electromagnetic field. In some embodiments, the step of applying a current to create an electromagnetic field changes the size, shape, surface charge, tortuosity, and combinations thereof of the membrane materials. The different features of the membrane material and the channel can be fine-tuned by altering the strength of the external stimulus. In some embodiments, the features of the at least one channel are changed by virtue of the external stimulus changing the membrane material. In some embodiments, the step of applying a current to create an electromagnetic field is controlled by a computing system connected to a power supply.

In some embodiments, the external magnetic field is less than 10 Tesla (T). In some embodiments, the external magnetic field is less than 5 T. In some embodiments, the external magnetic field is less than 2 T. In some embodiments, the external magnetic field is less than 1 T. In some embodiments, the external magnetic field is less than 950 mT. In some embodiments, the external magnetic field is less than 900 mT. In some embodiments, the external magnetic field is less than 800 mT. In some embodiments, the external magnetic field is less than 700 mT. In some embodiments, the external magnetic field is less than 600 mT. In some embodiments, the external magnetic field is less than 500 mT. In some embodiments, the external magnetic field is less than 450 mT. In some embodiments, the external magnetic field is less than 400 mT. In some embodiments, the external magnetic field is less than 350 mT. In some embodiments, the external magnetic field is about 200 mT. In some embodiments, the external magnetic field is about 300 mT. In some embodiments, the external magnetic field is about 400 mT. In some embodiments, the external magnetic field is about 500 mT.

In some embodiments, the external magnetic field is less than 900 micro Tesla (μT). In some embodiments, the external magnetic field is less than 800 μT. In some embodiments, the external magnetic field is less than 700 μT. In some embodiments, the external magnetic field is less than 600 μT. In some embodiments, the external magnetic field is less than 500 μT. In some embodiments, the external magnetic field is less than 400 μT. In some embodiments, the external magnetic field is less than 300 μT. In some embodiments, the external magnetic field is less than 200 μT. In some embodiments, the external magnetic field is less than 100 μT. In some embodiments, the external magnetic field is less than 50 μT. In some embodiments, the external magnetic field is less than 25 μT. In some embodiments, the external magnetic field is less than 10 μT.

In some embodiments, the electromagnetic field is less than 5000 V/m. In some embodiments, the electromagnetic field is less than 4000 V/m. In some embodiments, the electromagnetic field is less than 3000 V/m. In some embodiments, the electromagnetic field is less than 2000 V/m. In some embodiments, the electromagnetic field is less than 1000 V/m. In some embodiments, the electromagnetic field is less than 750 V/m. In some embodiments, the electromagnetic field is less than 500 V/m. In some embodiments, the electromagnetic field is less than 250 V/m. In some embodiments, the electromagnetic field is less than 100 V/m. In some embodiments, the electromagnetic field is less than 50 V/m. In some embodiments, the electromagnetic field is less than 25 V/m. In some embodiments, the electromagnetic field is less than 10 V/m.

In some embodiments, the radio frequency is less than 500 gigahertz (GHz), less than 100 GHz, less than 50 GHz, less than 500 megahertz (MHz), less than 300 MHz, less than 100 MHZ, less than 50 MHZ, less than 25 MHz, less than 5 MHz, less than 3 MHz, less than 1 MHz, less than 900 kilohertz (kHz), less than 500 kHz, less than 300 kHz, less than 100 kHz, less than 1 kHz, and/or less than 500 hertz.

In some embodiments, the step of dispersing a mineral in a solvent to create a mixture further comprises the step of adding an acid to the mixture. Exemplary acids include, but are not limited to, sulfuric acid, hydrochloric acid, and the like. In some embodiments, the step of adding an acid to the mixture decreases the pH of the mixture to less than 7. In some embodiments, the step of adding an acid to the mixture decreases the pH of the mixture to less than 6. In some embodiments, the step of adding an acid to the mixture decreases the pH of the mixture to less than 5. In some embodiments, the step of adding an acid to the mixture decreases the pH of the mixture to less than 4. In some embodiments, the step of adding an acid to the mixture decreases the pH of the mixture to less than 3. In some embodiments, the step of adding an acid to the mixture decreases the pH of the mixture to less than 2. In some embodiments, the step of adding an acid to the mixture decreases the pH of the mixture to about 1. In some embodiments, the step of adding an acid to the mixture decreases the pH of the mixture to about 2. In some embodiments, the step of adding an acid to the mixture decreases the pH of the mixture to about 3. In some embodiments, the step of adding an acid to the mixture decreases the pH of the mixture to about 4. to In some embodiments, the step of adding an acid to the mixture decreases the pH of the mixture to about 6.

In some embodiments, the step of dispersing a mineral in a solvent further comprises the step of adding a bacterial culture to the solvent. In some embodiments, the step of adding a bacterial culture to the solvent decrease the pH of the solvent. In some embodiments, the step of adding a bacterial culture to the solvent oxidizes the metals or minerals or both. Exemplary bacterial cultures are described elsewhere herein.

In some embodiments, the step of dispersing a mineral in solvent further comprises the step of adding a polymer to the solvent. In some embodiments, the step of dispersing a mineral in solvent further comprises the step of adding an inorganic material to the solvent. In some embodiments, the step of dispersing a mineral in solvent further comprises the step of adding chitosan particles to the solvent. In some embodiments, the step of dispersing a mineral in solvent further comprises the step of adding plasma to the solvent. In some embodiments, the step of dispersing a mineral in solvent further comprises the step of adding graphene oxide to the solvent. In some embodiments, the step of dispersing a mineral in solvent further comprises the step of adding activated carbon to the solvent. In some embodiments, the step of dispersing a mineral in solvent further comprises the step of adding a salt to the solvent such as lithium chloride or sodium chloride. Exemplary polymers, inorganic materials, and salts are described elsewhere herein.

In some embodiments, the method further comprises the step of pumping gas into the mixture. In some embodiments, the gas comprises is nitrogen gas. In some embodiments, the gas comprises oxygen gas. In some embodiments, the gas comprises argon gas.

### Method of Purification

In one aspect, the present invention relates to a method of purifying a fluid using the system and/or membrane material described herein. In some embodiments, the method comprises providing a feed solution comprising a particulate, contacting the feed solution with a membrane material such that the membrane material absorbs particulates to create a recovery solution free of the particulate, and collecting the recovery solution. In some embodiments, the membrane material comprises microorganisms, and the microorganisms absorb the particulate when the feed solution contacts the membrane material. In some embodiments, the step of collecting the recovery solution further comprises the step of recycling the recovery solution through the membrane material to maximize purity of fluid.

In some embodiments, the method comprises providing a feed solution comprising a particulate, contacting the feed solution with a first membrane material and a second membrane material, such that the first membrane material and the second membrane material absorb the particulate, to create a recovery solution free of the particulate.

In some embodiments, the present invention relates to a method of collecting a particulate from a feed solution using the system and/or membrane material described herein. In some embodiments, the method comprises providing a feed solution comprising a particulate, contacting the feed solution with a membrane material such that membrane material absorbs the particulate, and collecting the particulate.

In some embodiments, the step of contacting the feed solution with a membrane material further comprises the step of applying an external stimulus to the membrane material. In some embodiments, the external stimulus is a magnetic field, a radiofrequency, an electric current, and combinations thereof. In some embodiments, the magnetic field is applied externally and/or internally. In some embodiments, the step of contacting the feed solution with a membrane material further comprises the step of applying a magnetic field to the membrane material. In some embodiments, the magnetic field is an electromagnetic field. In some embodiments, the step of applying a magnetic field further comprises the step of changing the size, shape, surface charge, tortuosity, or combinations thereof of the membrane material and of the channel, as described elsewhere herein. In some embodiments, the step of applying a magnetic field to the membrane material attracts particulates into the membrane material, wherein the particulates accumulate in the membrane material for either separation, collection, or both.

In some embodiments, the membrane material comprises coils, and the step of contacting the feed solution with a membrane material further comprises the step of applying an electrical current to the coils to create the electromagnetic field described above. In some embodiments, the membrane materials described herein are magnetically responsive and thus can be fine-tuned to the desired characteristics described above by applying a magnetic field to the membrane materials with any or all of the steps described above. Changing the above characteristics of the membrane material allows for precise selectivity of the particulate being purified or collected. In some embodiments, the membrane materials have a fixed geometry and dimension, wherein an electromagnetic field can be applied during purification and switched off during cleansing phases, with no changes in shape and dimensions.

In some embodiments, the magnetic field is a pulsating magnetic field. In some embodiments, the magnetic field has a fixed direction. In some embodiments, the magnetic field has a dynamic direction. In some embodiments, the step of applying a magnetic field to the membrane material further comprises the step of changing the direction of particulate mass transfer within the membrane material. The above embodiments also apply when the magnetic field is an electromagnetic field. Exemplary strengths of the magnetic fields, and electromagnetic fields are described elsewhere herein.

In some embodiments, the step of applying a current to the membrane material using a power supply is done wirelessly. In some embodiments, the step of applying a current to the membrane material using a power supply is done by an automated computing system. In some embodiments, the power supply described herein comprises sensors configured to continuously measure changes in the feed solution, such as concentration, temperature, pH, ionic strength, redux potential, and the like. In some embodiments, the power supply described herein comprises controllers configured to send specific voltages to the coils described herein. In some embodiments, the step of applying a current to the membrane material using a power supply is done by an automated computing system connected to the power supply and thus connected to the sensors and controllers. In some embodiments, the automated computing system can process data from the sensors and relay a desired voltage to the controller, such that the automated computing system adjusts the size and shape of the membrane material depending on the data captured from the sensors.

In some embodiments, the current that is applied to the membrane material comprises a voltage. In some embodiments, the voltage is between 1 mV and 100 V. In some embodiments, the voltage is between 1 V and 100 V. In some embodiments, the voltage is greater than 1 mV. In some embodiments, the voltage is greater than 100 mV. In some embodiments, the voltage is greater than 500 mV. In some embodiments, the voltage is greater than 1 V. In some embodiments, the voltage is greater than 5 V. In some embodiments, the voltage is greater than 10 V. In some embodiments, the voltage is greater than 100 V. In some embodiments, the voltage is greater than 1 kV. In some embodiments, the voltage is greater than 10 kV. In some embodiments, the voltage is less than 1 mV. In some embodiments, the voltage is greater than 100 mV. In some embodiments, the voltage is less than 500 mV. In some embodiments, the voltage is less than 1 V. In some embodiments, the voltage is less than 5 V. In some embodiments, the voltage is less than 10 V. In some embodiments, the voltage is less than 100 V. In some embodiments, the voltage is less than 1 kV. In some embodiments, the voltage is less than 10 kV.

In some embodiments, the feed solution passes through any or all parts of the system with a linear velocity of greater than 0.01 cm/min, greater than 0.02 cm/min, greater than 0.03 cm/min, greater than 0.04 cm/min, greater than 0.05 cm/min, greater than 0.06 cm/min, greater than 0.03 cm/min, greater than 0.07 cm/min, greater than 0.08 cm/min, greater than 0.09 cm/min, greater than 0.1 cm/min, greater than 0.5 cm/min, greater than 1.0 cm/min, greater than 1.5 cm/min, greater than 2.0 cm/min, greater than 2.5 cm/min, greater than 3.0 cm/min, greater than 3.5 cm/min, greater than 4.0 cm/min, greater than 4.5 cm/min, or greater than 5.0 cm/min.

In some embodiments, the feed solution passes through any or all parts of the system with a linear velocity of less than 0.01 cm/min, less than 0.02 cm/min, less than 0.03 cm/min, greater than 0.04 cm/min, less than 0.05 cm/min, less than 0.06 cm/min, less than 0.03 cm/min, less than 0.07 cm/min, less than 0.08 cm/min, less than 0.09 cm/min, less than 0.1 cm/min, less than 0.5 cm/min, less than 1.0 cm/min, less than 1.5 cm/min, less than 2.0 cm/min, less than 2.5 cm/min, less than 3.0 cm/min, less than 3.5 cm/min, less than 4.0 cm/min, less than 4.5 cm/min, or less than 5.0 cm/min.

In some embodiments, the feed solution comprises a fluid. In one embodiment, the fluid comprises water. In one embodiment, the fluid comprises an emulsion. In one embodiment, the fluid comprises a drinking fluid. In one embodiment, the fluid comprises a beverage. In one embodiment, the fluid comprises a bodily fluid. In one embodiment, the fluid comprises blood. In one embodiment, the fluid comprises blood serum. In one embodiment, the fluid comprises an oil. In one embodiment, the fluid comprises milk. In one embodiment, the fluid comprises an alcohol. In one embodiment, the fluid comprises a solvent. In one embodiment, the fluid comprises an organic solvent. In various embodiments, the fluid may comprise any combination of water, drinking fluids, beverages, blood, blood serum, oils, milk, alcohols, solvents, and organic solvents.

In some embodiments the particulate is a molecule. In some embodiments, the particulate is a small molecule. In some embodiments, the particulate is a metal. In some embodiments, the particulate is a rare-earth metal. In some embodiments, the particulate is a metal. In some embodiments, the particulate is a toxic metal, such as uranium or thorium. In some embodiments, the particulate is an ion. In some embodiments, the particulate comprises an ion. Exemplary ions include but are not limited to calcium, hydrogen, hydroxide, aluminum, magnesium, sodium, potassium, lithium, strontium, barium, ammonia, carbonate, sulfate, chloride, cobalt, copper, neodymium, dysprosium, gallium, iridium, terbium, nitrate, boron, silicon dioxide, and iron. In some embodiments, the feed solution comprises a salt, including, but not limited to, sodium chloride (NaCl), lithium hydroxide (LiOH), lithium chloride (LiCl), potassium chloride (KCl), magnesium chloride (MgCl₂), magnesium carbonate (MgCO₃), magnesium sulfate (MgSO₄), calcium chloride (CaCl₂), calcium sulfate (CaSO₄), calcium carbonate (CaCO₃), potassium acetate (KAc) and calcium magnesium acetate (CaMgAc).

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the materials, devices, and kits of the present invention and practice the claimed methods. The following working examples, therefore, specifically point out exemplary embodiments of the present invention, and are not to be construed as limiting in any way the remainder of the disclosure.

### Materials

Scaffolds were doped with Erbium (Er), Europium (Eu), Gadolinium (Gd), Lanthanum (La), Neodymium (Nd), and Yttrium (Y). The following lanthanide salts (chloride) were used to dope the scaffolds at various doses. Europium (III) chloride (Eu Cl₃) hexahydrate (6H₂O) 96% from Tokyo Chemical Industry, Neodymium (III) chloride (Nd Cl₃) 99.9% anhydrous from Alfa Aesar, Gadolinium (III) chloride (Gd Cl₃) hexahydrate, and Erbium (III) chloride (Er Cl₃) anhydrous from Alfa Aesar. Also, a transition metal Yttrium (Y), as Yttrium (III) chloride (Y Cl₃) hydrate 99.9% from Alfa Aesar, was used to dope scaffolds.

Sodium phosphate monobasic (Na H₂ PO₄) 99% from Sigma-Aldric was also used to modify scaffolds dopped with lanthanides. Phosphate (PO₄³⁻) was added to react with residual lanthanides left in the scaffolds to modify the structures. Yellow gels were obtained by adding phosphate (PO₄³⁻) to saturated scaffolds with La³⁺.

Graphene: Single layer graphene oxide 99%, with 0.7-1.2 nm thickness and 1-20 um X-Y dimensions obtained from Cheap Tubes Inc., were used to seal between the pores of the membrane. Graphene oxide can either be added to the solution before pouring the membrane solution over the circulars magnetics to form the membrane pours or can be sprayed over the membrane after formation of pores over the circular magnets. Plasma was used to alter chemical and physical properties of graphene.

MXene: A family of MXene 2 dimensional materials, including Ti₃AlC₂ and Ti₃C, were used to functionalize the membrane surface and pores. Additionally, other MXene materials such as Niobium Carbide (Nb₂CTx), Chromium Carbide (Cr₂C), Vanadium carbide (V₂ CTx), and Titanium Carbide (Ti₂CTx) nanoflakes can be used to finetune structures responsiveness to electromagnetic fields and electromagnetic shielding.

### Example 1: Porous Gel-Like Materials

There is a notable lack of ability to effectively incorporate biological elements within separation membrane systems, limiting the potential for biologically mediated processes and bio-inspired separation mechanisms. Additionally, membrane systems often lack the agility to dynamically adjust their properties or separation performance in response to fluctuating environmental conditions or varying feed compositions, which restricts their adaptability in real-world scenarios. Addressing these limitations requires a multifaceted approach, involving the development of advanced materials, cutting-edge membrane technologies, and the incorporation of adaptive and responsive mechanisms. This approach aims to improve performance, environmental sustainability, and the overall flexibility of membrane separation systems.

Incorporation of Biological Components: The integration of biological components into membrane structures marks a groundbreaking advancement in membrane technology, significantly enhancing their specificity and adaptability for targeted separation processes. This approach leverages the innate ability of biological molecules to selectively recognize and interact with specific substances, thereby facilitating a leap forward in the selectivity and operational efficiency of membrane-based separations. Such biofunctionalization not only promises to streamline separation processes but also introduces the capability for membranes to mimic responsive and adaptive characteristics inherent to biological systems.

Agility in Response to Environmental Changes: Enhancing membrane systems to dynamically adjust their properties and performance in response to changing environmental conditions and feed compositions is essential. Such adaptability is vital for navigating the variability encountered in real-world settings, where traditional membranes' fixed operational parameters often fall short. The rigid nature of conventional membrane technologies restricts their applicability in situations with unpredictable feed stream characteristics. The introduction of membranes engineered for dynamic adaptability, through the use of responsive materials or the integration of biological functionalities, marks a significant leap forward. This advancement enables an unprecedented level of operational flexibility, essential for addressing the diverse and fluctuating demands of practical applications. The move towards more adaptive membrane designs is essential for expanding capabilities of membrane technologies, making them more efficient and versatile for complex separation processes.

Biomimetics of Mammalian Colon: A biomimetic approach, inspired by the complex processes of intestinal digestion, aims to replicate the structure and function of the intestine to develop separation systems that mimic its efficient nutrient absorption and waste processing. This methodology finds application across diverse fields such as materials science, bioreactor design, and drug delivery systems.

Below is an enhanced conceptualization of such an approach:
1. Modular Configuration Reflecting Intestinal Functions: Systems are structured into distinct modules that replicate the specialized functions of the intestinal segments. Each segment features tailored conditions and specific biological, chemical, or physical environments to simulate the breakdown and selective absorption of various ions and molecules.
2. Enhanced Surface Area through Micro and Nanostructures: Surfaces are designed to replicate the villi and microvilli's structure, which expands the surface area available for interaction. This enhancement is pivotal for boosting absorption efficiency in synthetic digestive systems.
3. Controlled pH Gradient Implementation: A meticulously controlled environment that replicates the intestinal pH gradient-from acidic to neutral to slightly alkaline, or the opposite.
4. Integration of Microbial Symbiosis: Emulating the colon's microbial fermentation and incorporating beneficial microbes into bioreactors or waste treatment systems breaks down complex organic matter of target or competing ions or molecules.
5. Peristalsis Simulation: Systems employ mechanical movements or fluid dynamics that mimic peristalsis, promoting efficient material movement and mixing, thus enhancing breakdown and absorption processes akin to the natural model.
6. Selective Absorption and Transport Mechanisms: Developing materials or membranes with selective permeability replicate the intestine's selective absorption capabilities.
7. Integration of Feedback Systems: Incorporating sensors and feedback loops to regulate enzyme release, pH levels, and peristaltic actions, similar to the hormonal and neural regulation in the intestine optimize system performance in response to varying inputs and dynamic environmental conditions.

### Synthesis of Hydrogels

Iron disulfide (FeS₂), also known as pyrite (FeS₂), has garnered significant attention due to its ideal band gap and exceptionally high optical absorption coefficient in the visible spectrum. In the field of sustainable energy materials research, advanced iron pyrite nanocrystals have become a key area of interest due to their promising potential in optoelectronic and electrochemical applications. Recent advancements have leveraged innovative synthesis strategies, notably integrating LaMer theory and the oriented attachment growth mechanism, to achieve precise control over the size, shape, and crystallinity of these nanocrystals. Such developments aim to address and rectify the persistent challenges associated with defects and uncontrolled crystal growth in pyrite materials.

Technical Challenges in Synthesis of Engineered Pyrite Nanomaterials and Composites: Advancing pyrite nanotechnology involves overcoming challenges in synthesizing high-quality FeS₂ nanostructures with precise control of their properties. Key issues include defect management, controlled crystal growth, and environmental stability which impacts device performance. Current focus is on fine-tuning particle size, developing tunable structures, and innovating composites for specific applications. Gaining precise control over the size and arrangement of nanocrystals, along with integrating pyrite with other materials, can open up new opportunities in energy, storage, and catalysis.

Magnetic fields offer a potential method for synthesizing pyrite nanostructures with precise control. Recent advancements in the synthesis and assembly of membrane materials have underscored the significance of magnetic fields in shaping and organizing innovative structural forms, highlighting their pivotal role in advancing materials science. A weak magnetic field ranges from 0.01 Tesla (T) to 0.1 T, while fields above 1.0 T are deemed strong. Magnetic fields stronger than 1.0 T can also be generated, with artificial pulsed magnetic fields currently reaching up to 100 T. Magnetic fields can profoundly modify the atomic and molecular configurations of materials, thereby significantly influencing their chemical characteristics and reactions at the most basic level and showcasing the profound impact of magnetic fields on materials science.

Pyrite demonstrates magnetic properties that are typically classified as weak, exhibiting primarily paramagnetic characteristics. The magnetic properties of pyrite are shaped by its cubic crystal structure, the presence of defects and impurities, and the electronic configuration of iron atoms. The arrangement of iron and sulfur within pyrite's lattice results in weak magnetic behavior. Defects, such as excess iron, may induce ferromagnetic characteristics by forming pyrrhotite which alters pyrite's magnetic response. Furthermore, the low-spin state of iron atoms, due to the sulfur's ligand field, reduces the magnetic moment. These elements collectively render pyrite predominantly paramagnetic, with its magnetic properties varying according to composition and structure.

Applying magnetic fields both externally and internally to membranes exhibiting magnetic properties offers a sophisticated technique for precisely controlling their structure and behavior. This enables the manipulation of membrane structures through alignment, deformation, and the addition of new functionalities. This could be achieved by the interaction between the magnetic fields and the magnetic particles within or on the membrane. Utilizing magnetophoresis (movement of particles under a magnetic field) and magnetic torque (rotational force), this approach can selectively modify membrane permeability, improve separation processes, and assist in the construction of nanostructured materials. The deliberate integration of magnetic nanoparticles or coatings within a membrane framework permits exact control over its features, influenced by the magnetic fields. This not only paves the way for developing enhanced filtration systems, drug delivery mechanisms, and smart materials for medical and environmental uses, but also underscores the importance of fine-tuning the magnetic field's strength, its gradient, and directionality. Furthermore, the success of this technique depends on the careful selection of magnetic particle properties and the membrane's chemical characteristics, ensuring targeted and efficient outcomes.

Erbium (Er), europium (Eu), gadolinium (Gd), and neodymium (Nd) are rare earth elements within the lanthanide series, distinguished by their distinct electronic configurations that give them unique chemical and physical characteristics. These elements are pivotal in numerous high-technology applications, leveraging their extraordinary magnetic, luminescent, and conductive properties.

Erbium (Er) is celebrated for its pronounced absorption bands across visible, ultraviolet, and near-infrared spectra, playing a critical role in enhancing the performance of optical fiber amplifiers and lasers, and in the alloying process of vanadium steel to improve its mechanical attributes. Its efficiency in absorbing infrared light is particularly harnessed in medical lasers for dermatological and dental procedures.

Europium (Eu) distinguishes itself through its vibrant red phosphorescence, indispensable for achieving the vivid red hues in electronic screens. This characteristic is a result of europium's f-electron transitions, exquisitely sensitive to the crystal field's influence, making it a principal agent in the fabrication of luminescent materials for imaging and illumination purposes.

Gadolinium (Gd) boasts unique paramagnetic qualities, notably beneficial in the formulation of magnetic resonance imaging (MRI) contrast agents to amplify the distinction between healthy and pathological tissues. Additionally, its remarkable capacity for neutron absorption renders it invaluable in nuclear reactor operations as an effective neutron damper.

Neodymium (Nd) is renowned for its potent magnetic properties, essential for the production of neodymium-iron-boron (NdFeB) magnets, among the most powerful permanent magnets available. These magnets are integral to a variety of devices, including electric motors, wind turbines, and hard disk drives. Furthermore, neodymium's optical traits are leveraged in lasers for material processing and surgical applications.

Collectively, these elements underscore the wide-ranging utility of rare earth elements in propelling technological advancements across diverse sectors, including electronics, energy, medicine, and materials science. Their distinct properties are instrumental in the development and innovation of critical devices and systems.

The present invention's method systematically synthesizes pyrite composites comprising lanthanides at room temperature utilizing low to medium-range magnetic fields. This encompasses the innovative use of acidophiles in biosynthesis, covering both aerobic and anaerobic settings, and across pH environments from acidic to neutral, highlighting a significant leap in the versatile synthesis of pyrite materials. This innovative approach synthesizes pyrite composites at room temperature without the need for high temperatures, additives, or surfactants.

Hydrogels of Pyrite: Hydrogels, known for their substantial water retention within three-dimensional polymeric networks, serve diverse applications in biomedical, environmental, and pharmaceutical sectors. While extensive research has investigated the synthesis, properties, and applications of hydrogels and pyrite nanocrystals—especially in energy storage, catalysis, and photovoltaics—the integration of pyrite with hydrogel systems has been less explored. This gap offers a unique opportunity for groundbreaking research to leverage the distinctive properties of pyrite nanocrystals within hydrogel matrices, potentially paving the way for new advancements in materials science and various application fields.

Novel gel-like porous pyrite and pyrite composites were synthesized, a development not previously documented in scientific literature. These porous hydrogels feature expansive channels within their structures, akin to aquaporins. This marks the first instance of reporting the creation of aquaporin-mimetic structures utilizing pyrite composites, signifying an important advancement in the field of materials science.

Scanning electron microscopy (SEM) images revealed that the synthesized pyrite-based materials exhibit a predominantly porous structure with an intricate network. These materials are not only porous and capable of retaining water but also display a variety of hydrogel morphologies. The synthesis method and the incorporation of different elements lead to diverse composite structures. Under magnetic conditions post-synthesis or when subjected to shear forces, the materials exhibit distinct behaviors. Notably, exposure to lateral shear forces transforms the gel-like materials into web-like macrostructures, demonstrating the dynamic and responsive nature of these pyrite-hydrogel composites to physical forces.

Biogenic Synthesis of Pyrite-Based Composites: The biogenic synthesis of pyrite employs the use of biological agents, including microorganisms and plant extracts, to facilitate the production of pyrite nanoparticles. Embracing a green chemistry paradigm, this method aims to generate nanoparticles characterized by distinct crystal structures and morphologies, utilizing an eco-conscious approach. By harnessing the bio-reduction potential of these agents, it presents a viable, sustainable alternative to traditional chemical synthesis techniques. The environmentally friendly method of biogenic FeS₂ synthesis holds great promise in fields like catalysis, photovoltaic systems, environmental clean-up, and energy storage solutions. Its semiconducting properties and the ability to create high-capacity battery electrodes make it an exciting material for these applications. Ongoing research is dedicated to refining this synthesis process and unveiling novel applications for these innovative nanoparticles.

The biogenic synthesis of FeS₂ nanoparticles leverages specialized bacteria, including sulfate-reducing bacteria like Desulfovibrio spp. and iron-reducing bacteria such as Shewanella oneidensis, to catalyze the transformation of sulfate and iron ions into sulfide and ferrous ions. These ions subsequently react to produce pyrite. This method epitomizes a green chemistry approach, employing biological systems to fabricate nanoparticles with unique characteristics in an environmentally sustainable manner. The nanoparticles produced through this biogenic route show potential for diverse applications, including catalysis, photovoltaics, environmental remediation, and energy storage. This highlights the viability of biogenic synthesis as an eco-friendly alternative to traditional chemical synthesis methods. Current research efforts are directed towards refining this biosynthesis process, aiming to improve the yield and broaden the utility of the synthesized nanoparticles.

Recent studies emphasize the key role of sulfate-reducing bacteria, such as Desulfovibrio desulfuricans, in the biogenic synthesis of pyrite nanoparticles. These bacteria, by interacting with specific iron sources like amorphous Fe(III)-phosphate nanoparticles, enable pyrite formation under certain conditions. Research highlights the importance of the microbial community's composition, particularly with bacteria like Desulfovibrio and Sulfurospirillum, in the biomineralization process. Their ability to reduce sulfate to sulfide is crucial for the rapid formation of black iron sulfides, demonstrating the significant interplay between microbial diversity and chemical conditions in synthesizing pyrite and related minerals. Composites of pyrites have the potential to be biogenically synthesized using acidophiles under magnetic conditions.

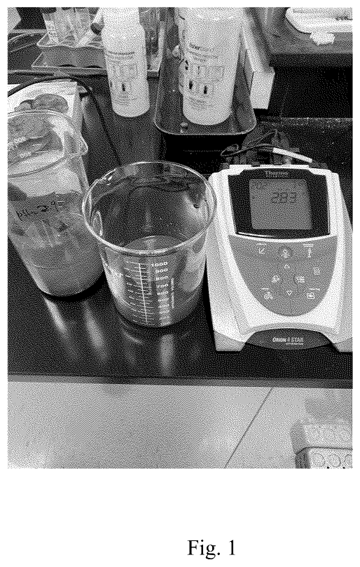

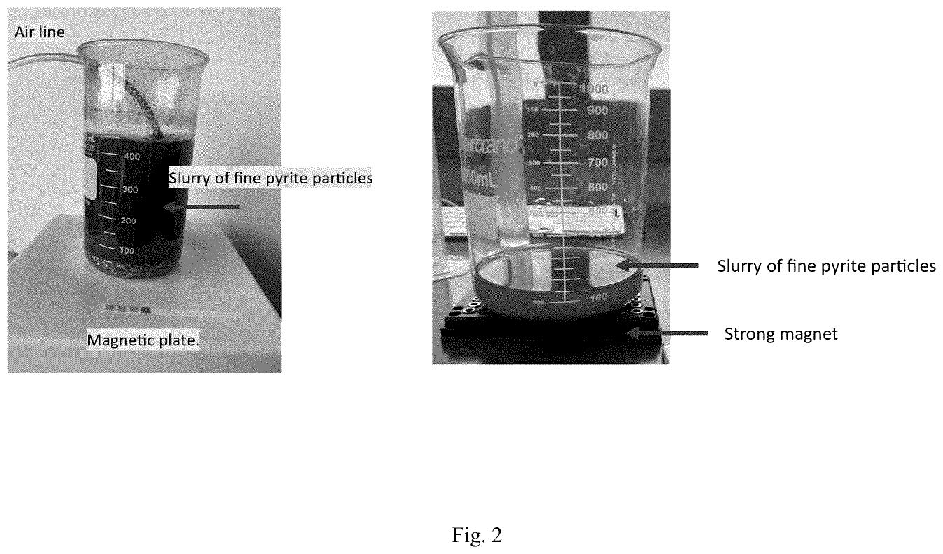

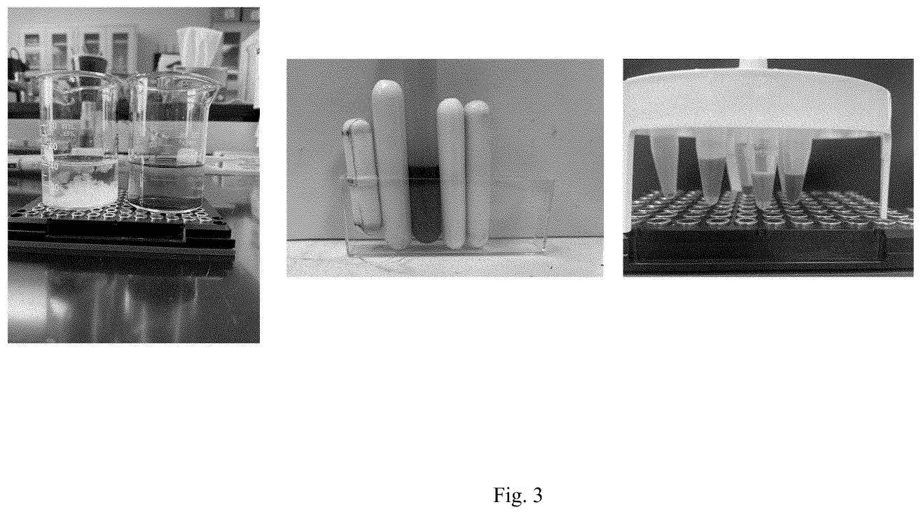

Synthesis Method of Pyrite Hydrogels: Initially, pyrite is finely milled and ground to obtain very small particles. These particles are then transferred to a beaker filled with water. The pH is adjusted using sulfuric acid to achieve an acidic environment, particularly if biogenic synthesis involving acidophiles is targeted (FIG. 1). The pH can be further adjusted by acidophilic chemolithotrophic bacteria. Alternatively, abiotic composite formation can be pursued. The slurry of pyrite particles is stirred continuously for several days up to a week using a magnetic stirrer, after which the stirring is stopped. Bacterial cultures such as Acidithiobacillus ferrooxidans, Leptospirillum ferrooxidans, Acidithiobacillus thiooxidans, or Sulfobacillus species can be used for biogenic synthesis of the porous structure and/or adjustment of pH. Depending on the desired structural characteristics, air can be continuously pumped in to maintain oxidizing conditions. For anaerobic conditions, nitrogen gas can be purged through the slurry for several days. Once the slurry has been mixed for up to a week, the beaker is then placed on a magnet for several days up to a week (resting phase) until hydrogels are formed (FIG. 2). Different types of magnets, magnetic shapes, and/or external magnetic fields affect the physical characteristics of the porous structure (FIG. 3).

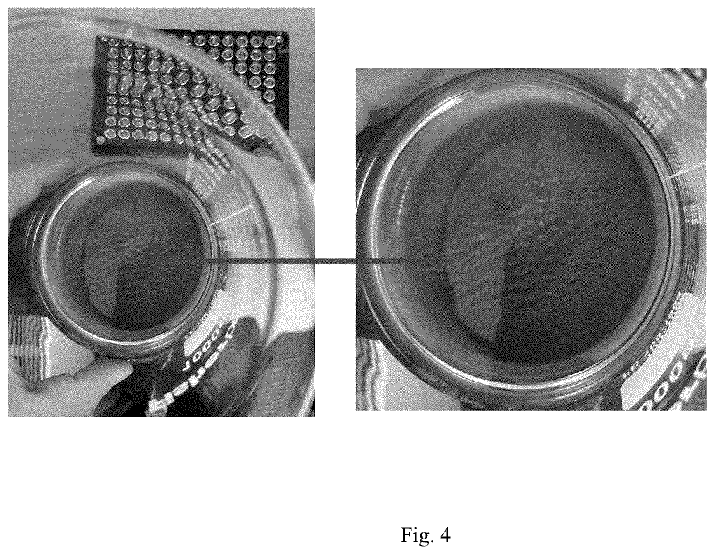

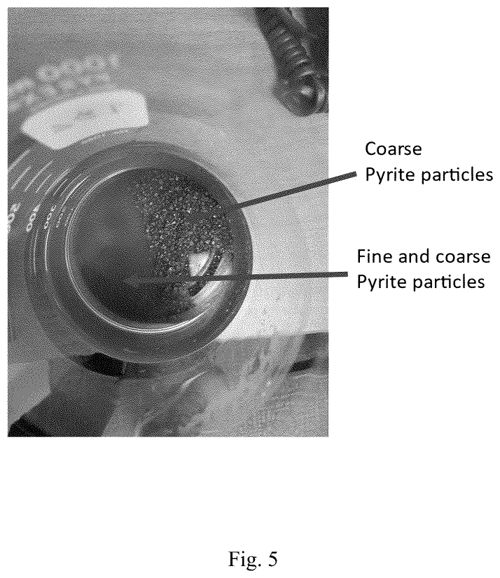

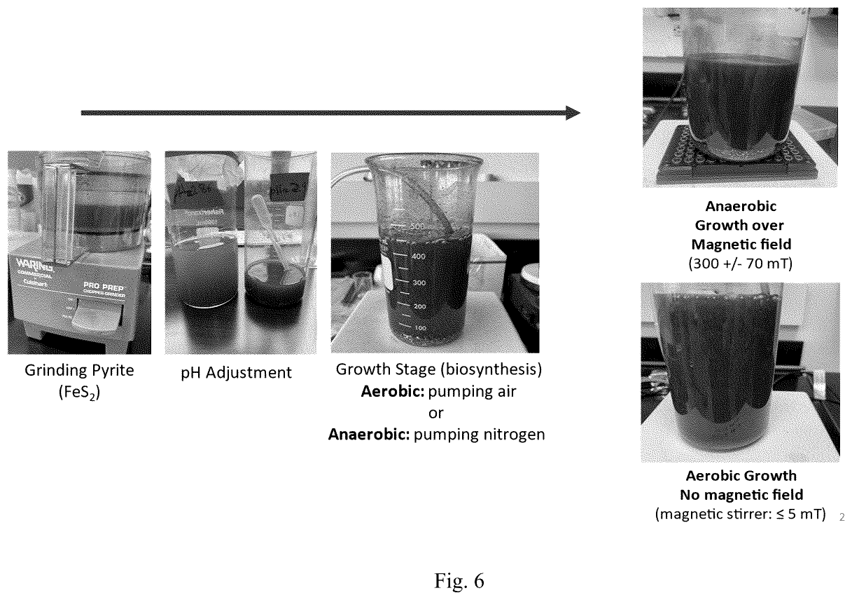

In some instances, a 96-well magnetic plate, typically used for separation of magnetic beads from DNA or RNA solutions, is used as an external magnetic field. The use of such a magnetic field, where there are multiple string magnets lined in rows and columns, allowed formation of gel-like materials that have an internal structure resistant to small shear forces (FIG. 4). FIG. 5 shows coarse pyrite particles representing the porous gel-like structures. Lanthanides can be introduced during the mixing phase or added at the end during the resting phase to adjust the desired structures, morphologies, and properties. FIG. 6 illustrates an overall synthesis method.

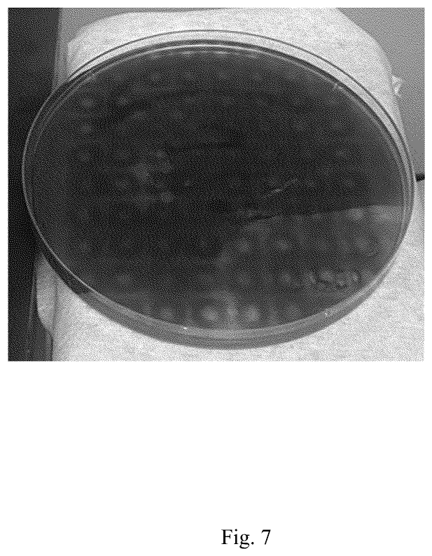

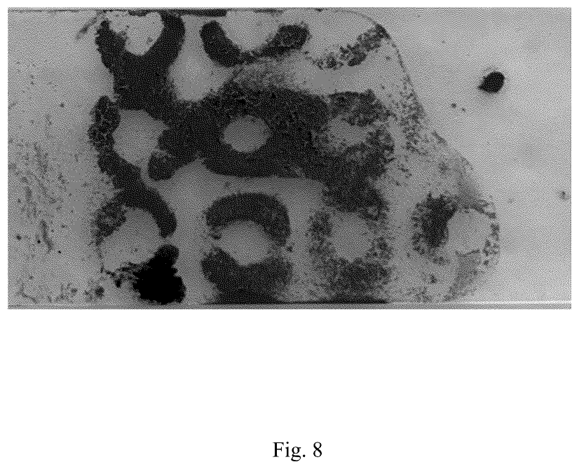

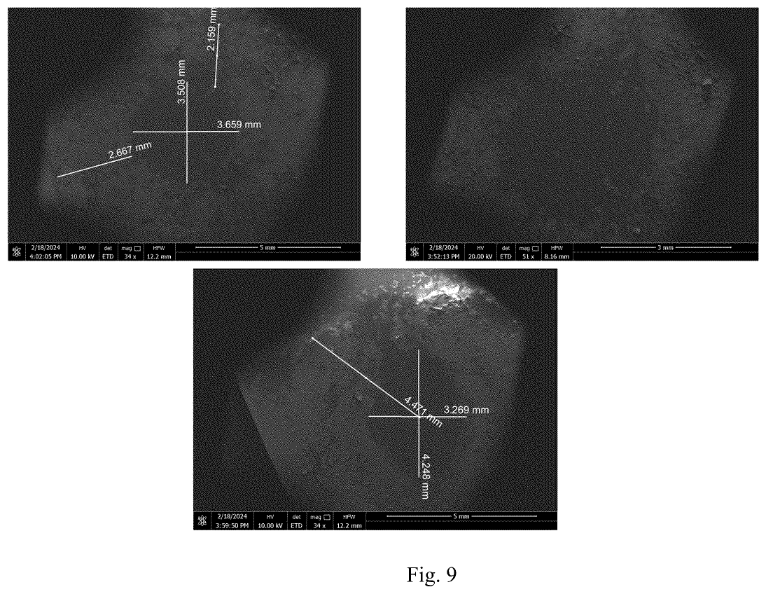

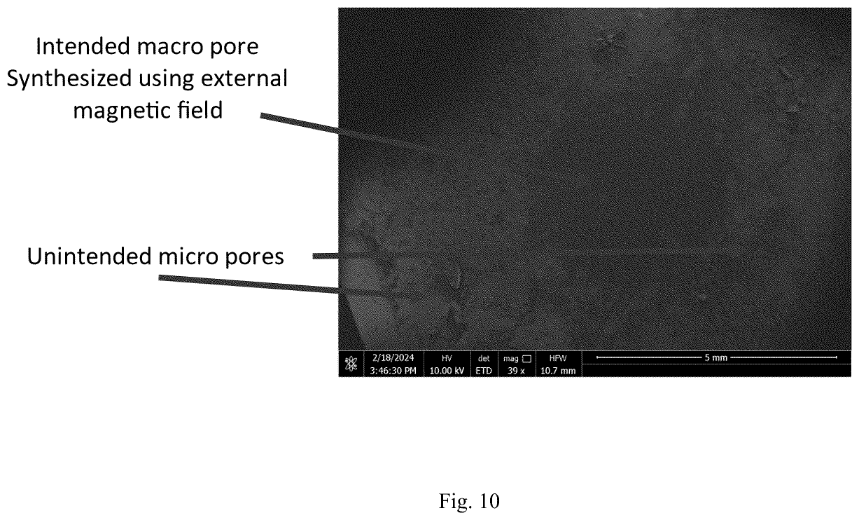

Metallic magnetic porous pores (scaffolds/composites of membrane pores) were formed using an external magentic field prior to adding a polymeric composite to fabricate the membrane. FIG. 7 shows the formation of europium-pyrite composites to construct membrane pores in a petri dish. FIG. 8 shows the formation of neodymium-pyrite composites to construct membrane pores on a glass slide. FIG. 9 shows SEM images of the neodymium-pyrite composites (millimeter scale), the pore synthesis should be done in the scale of micrometer to nanometer, depending on the application. A SEM image on FIG. 10 shows a closer look at the neodymium-pyrite composite. The intended macro pore can be visualized as well as unintended micro pores on the edges of the larger pore. At the microscale, the material does not form a homogenous structure and so graphene oxide was employed to synthesize a homogenous material.

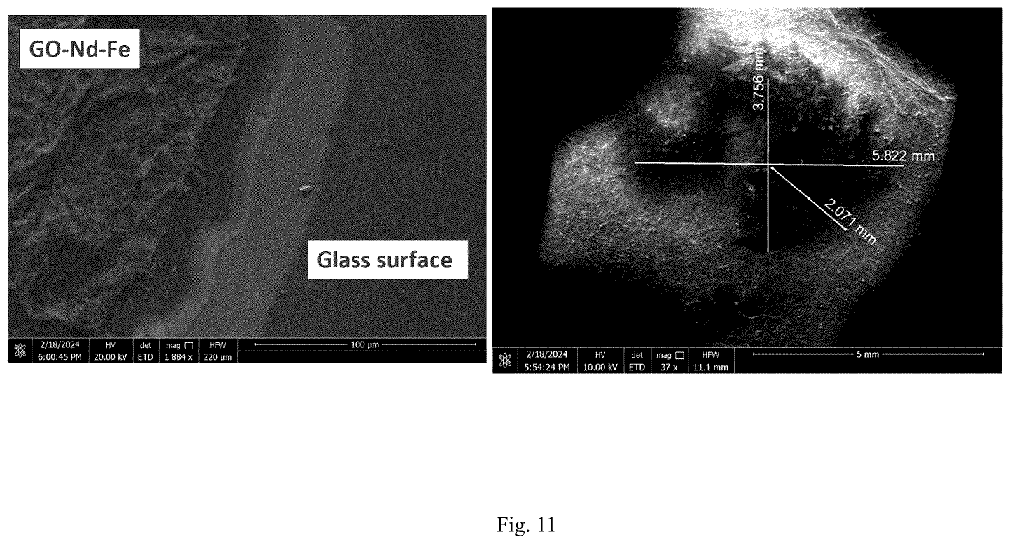

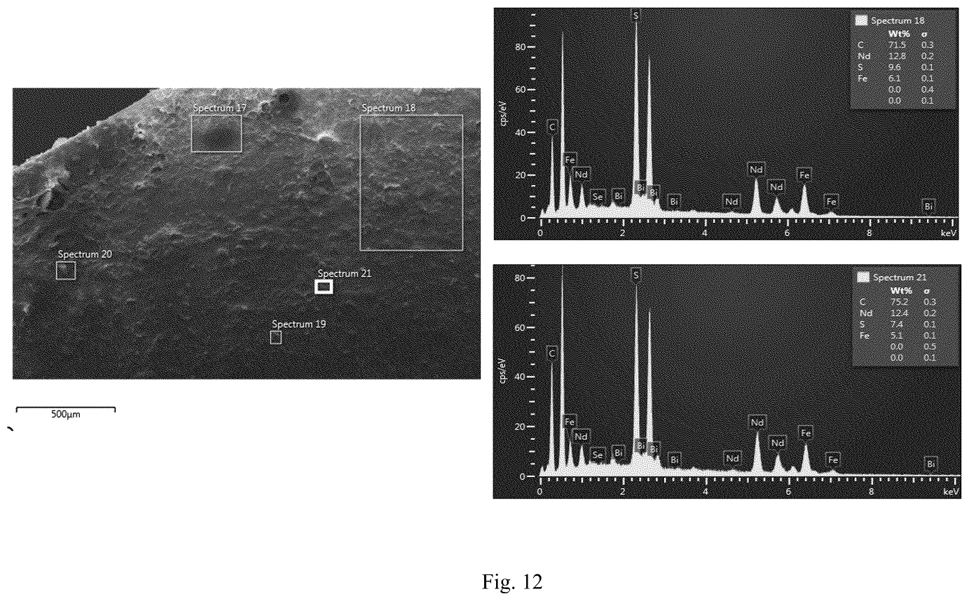

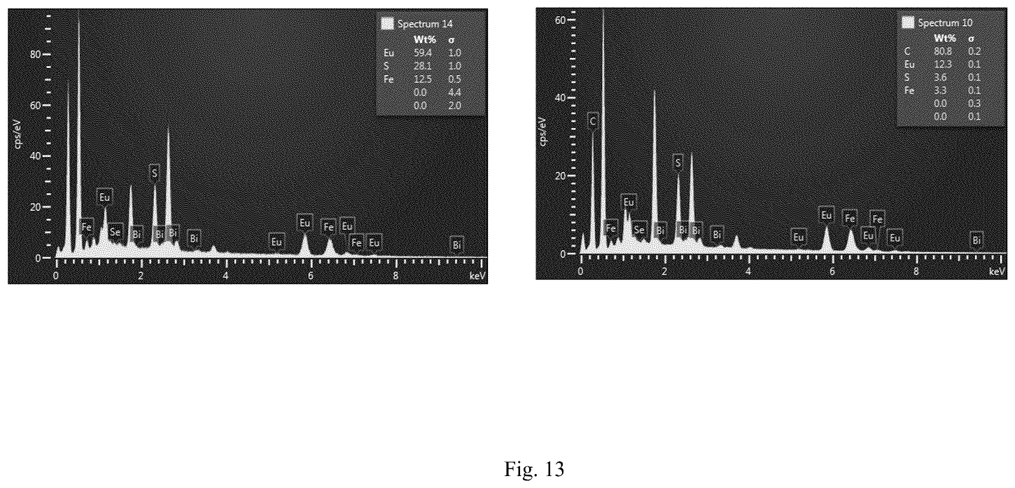

Graphene oxide was added to the lanthanide-iron composites to synthesize a homogenous scaffold that prevents the formation of unintended micro pore/openings. Graphene oxide (GO) is a two-dimensional material with a honeycomb lattice of carbon atoms. It is distinguished by its high surface area, and tunable electrical and optical properties, which result from the presence of oxygen-containing functional groups attached to the carbon atoms. Furthermore, GO facilitates efficient electron transfer, as its unique structure allows oxygen-functional groups on the carbon lattice to function as electron acceptor sites. Here, GO was used to synthesize the membrane sheets for efficient electorn transfer throughout the sheet structure, and potentially adding a variety of functional groups on graphene sheets. Addition of graphene oxide prevented the formation of unintended pores, however, the accuracy of the circular pores decreased as the ferromagnetism of the composite suffered (FIG. 11). FIG. 12 shows energy-dispersive X-ray spectroscopy (EDS) data of graphene oxide-neodymium-pyrite composites formed on a glass slide. FIG. 13 shows energy-dispersive X-ray spectroscopy (EDS) data of graphene oxide-europium-pyrite composites formed on a glass slide. These compositions can be adjusted based on the expected application and desired characteristics. The magnetic susceptibility, neutron absorption, and optical characteristics, can all be accounted for in the synthesis.

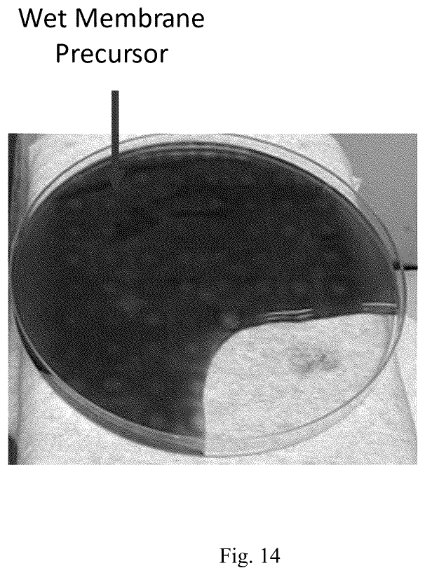

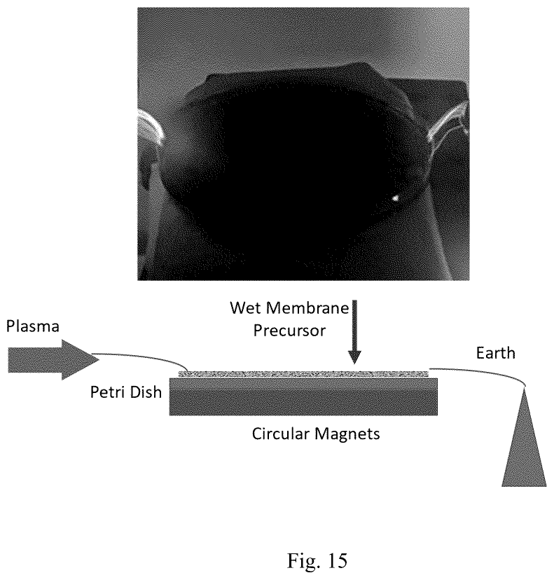

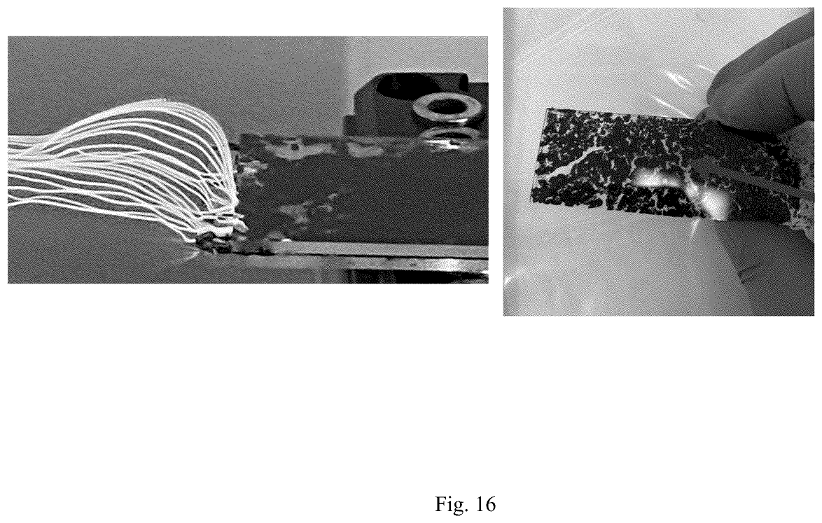

Plasma can further be used to synthesize microfluidic porous structures (FIG. 14). Wet graphene-pyrite-europium/neodymium precursors were placed in between two glass slides (FIG. 15). The plasma was used to dry the mix and generate random pores (FIG. 16).

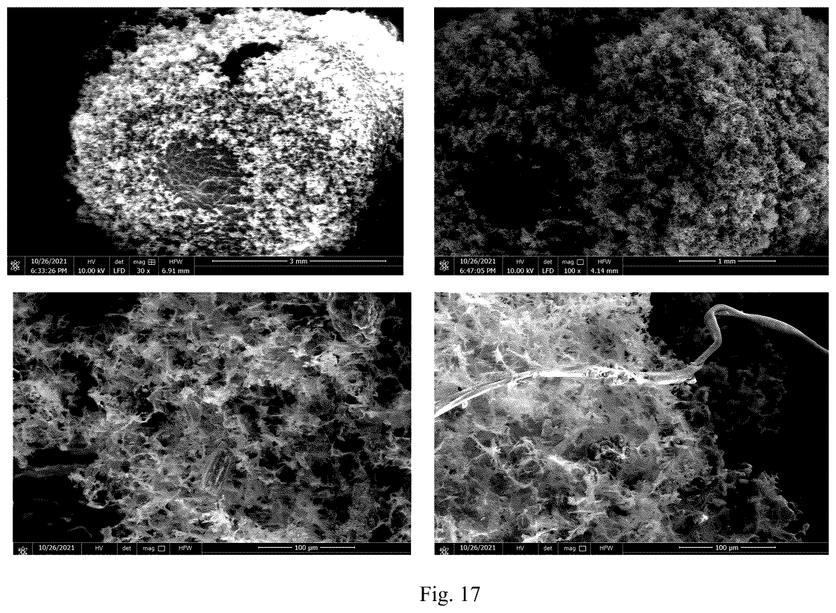

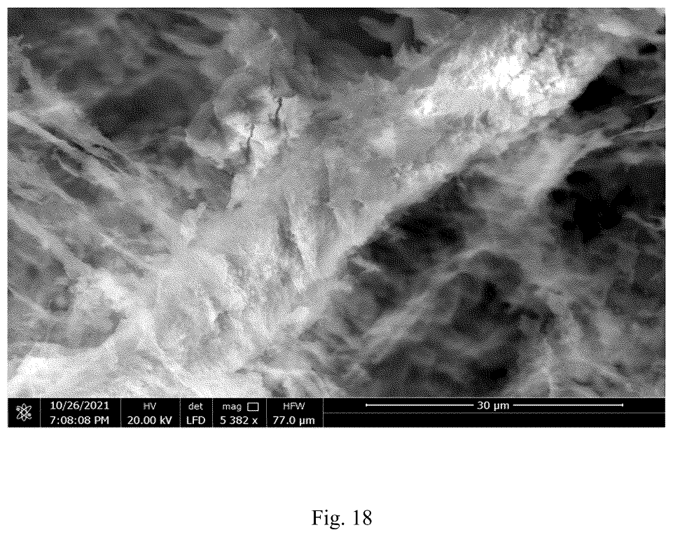

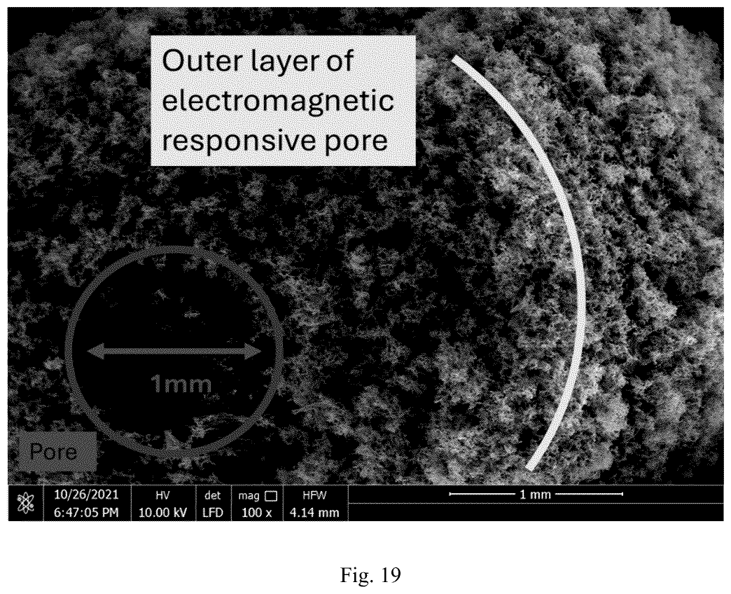

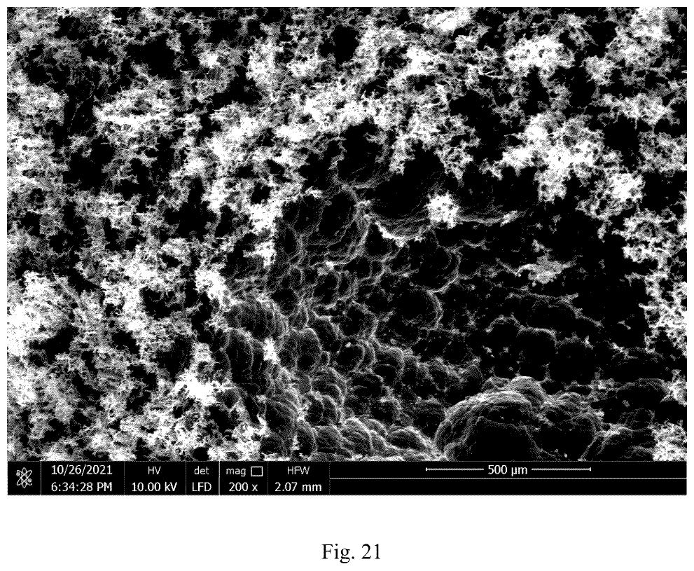

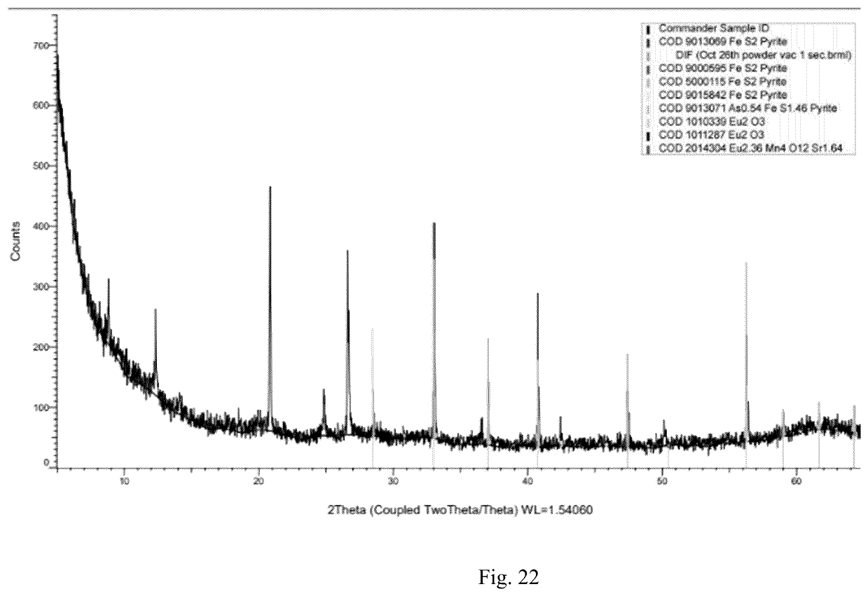

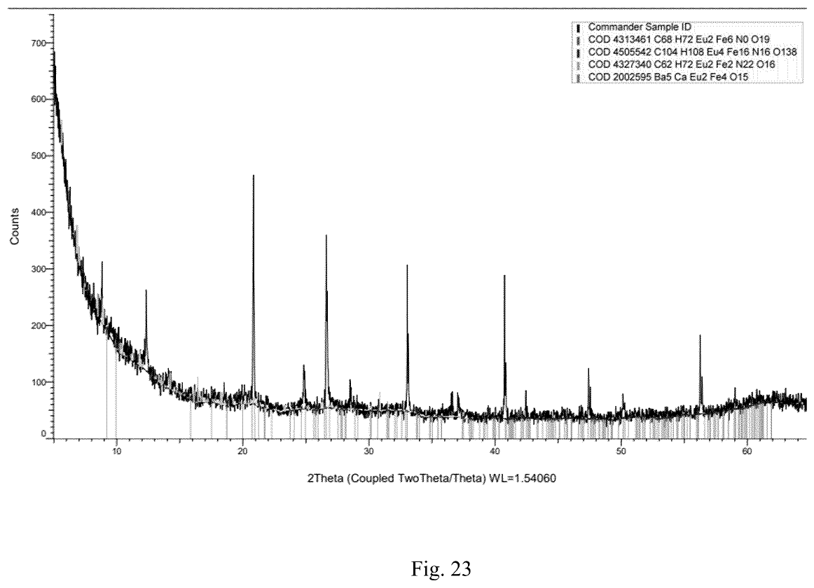

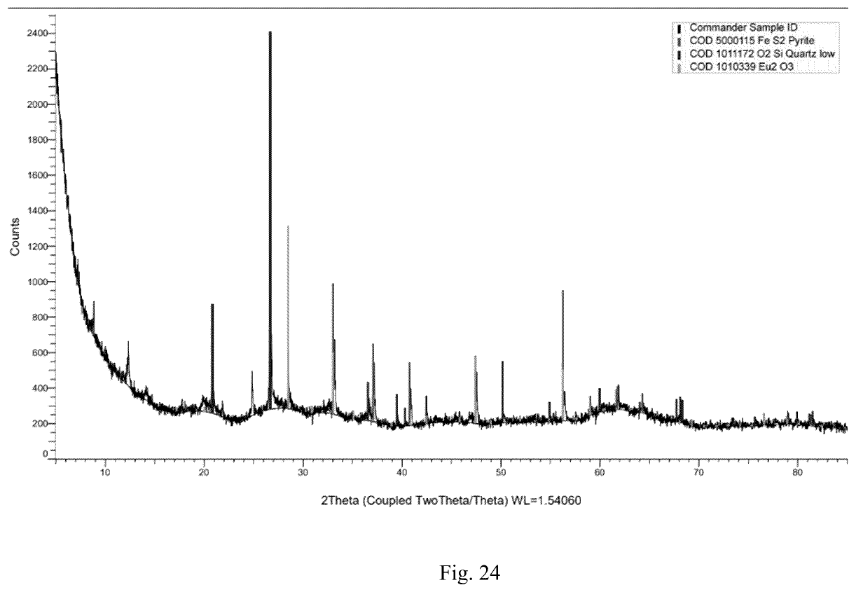

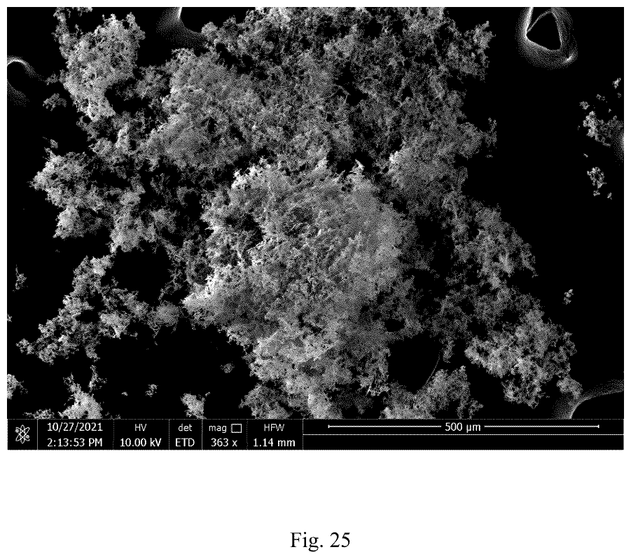

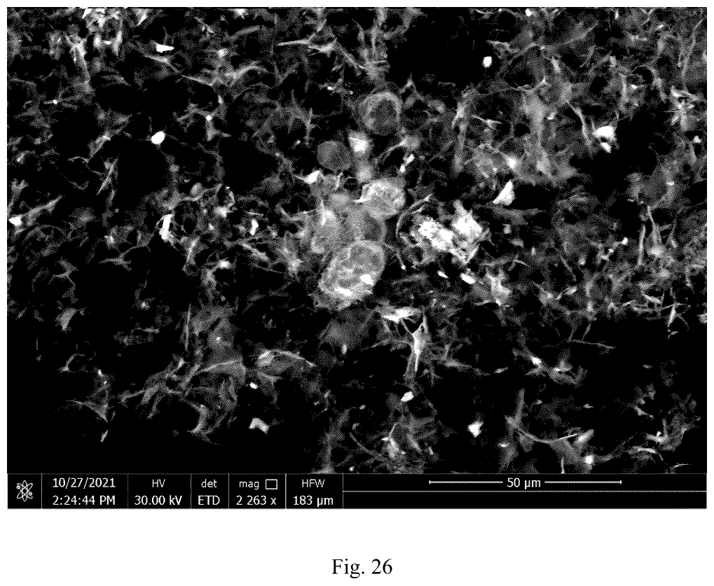

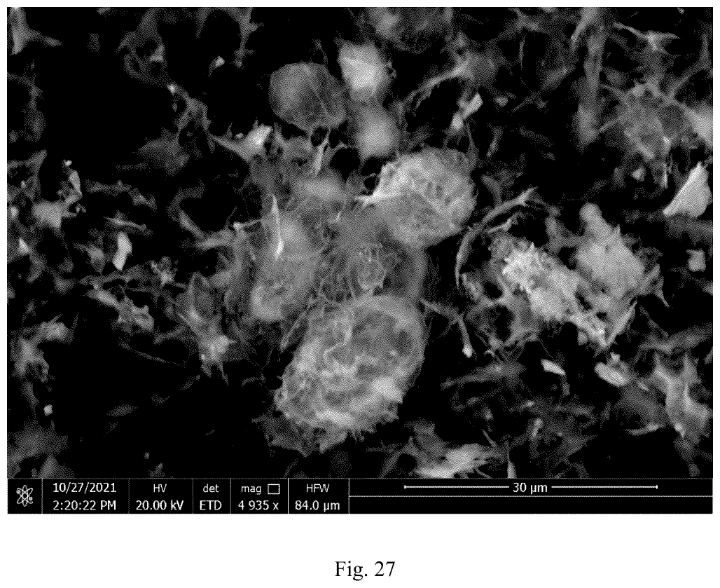

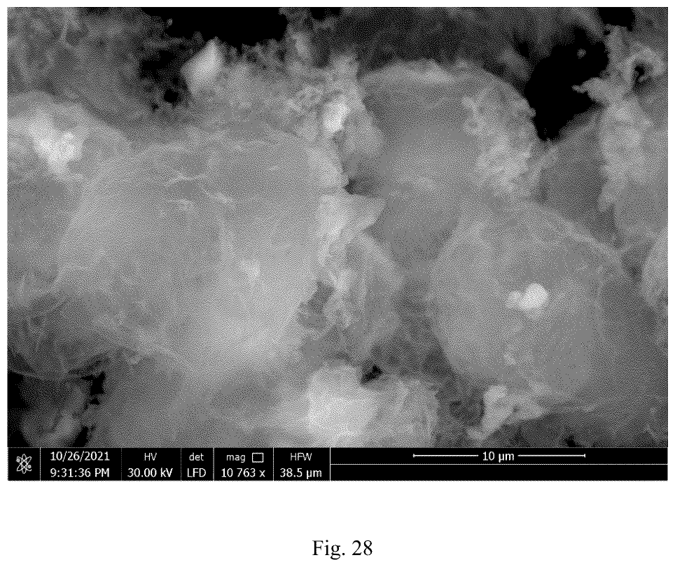

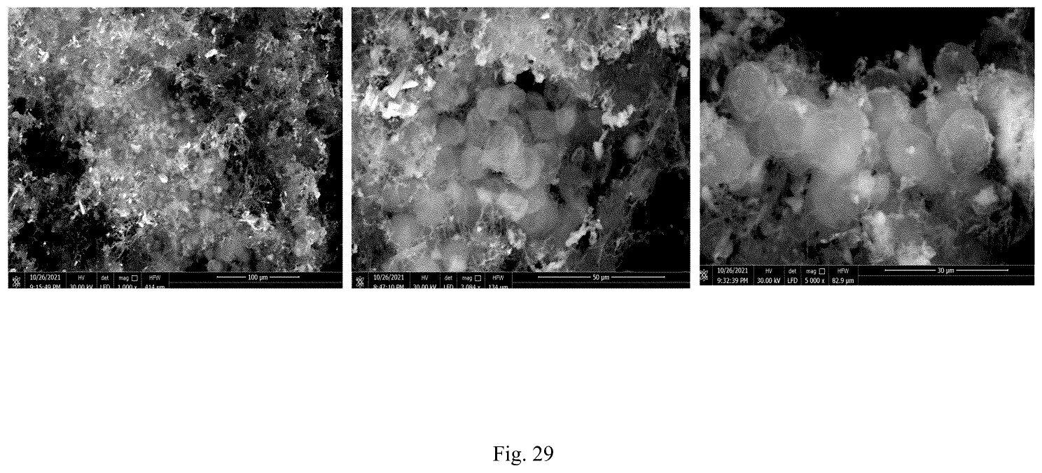

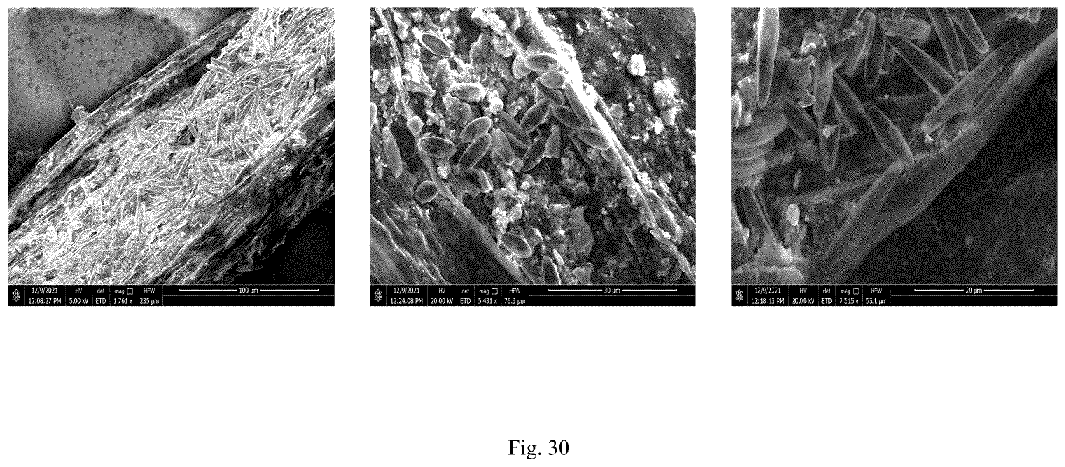

Europium-pyrite composites were further analyzed and their SEM images are shown in FIG. 17, FIG. 18, FIG. 19, FIG. 20, and FIG. 21. FIGS. 19 and 20 show the cylindrical inner and outer layers of the electromagnetic responsive core of the europium-pyrite composite, noting the pore is about 1 millimeter wide and the whole scaffold is about 6 millimeters wide. X-ray diffraction (XRD) analysis was used to acquire the composite's diffraction pattern and identify the peak, phases, lattice constant, and interlayer spacing. FIG. 22, FIG. 23, and FIG. 24, show powder XRD diffractograms of the europium-pyrite composite. FIG. 25, FIG. 26, FIG. 27, and FIG. 28 show SEM images of neodymium-pyrite composites. FIG. 29 shows SEM images of neodymium-pyrite composites, wherein bioabsorption has caused the accumilation of high concentrations of neodymium. FIG. 30 shows SEM images and the natural occurrence of diatoms in the composites, which suggests they might have an impact in the early formation of certain structures of pyrite composites.

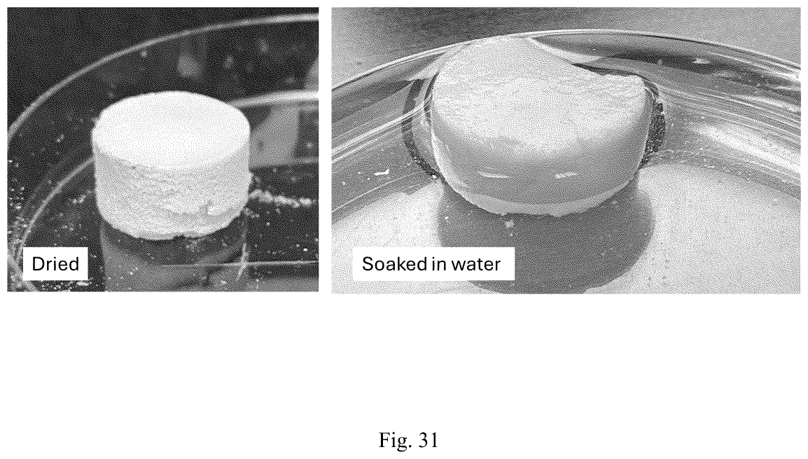

In one embodiment, pyrite composites saturated with lanthanides can be used as an adsorptive porous adsorbent for phosphate adsorption where lanthanide phosphate is locked in the pyrite scaffold (FIG. 31). Alternatively, the scaffold with phosphate can be used for the adsorption and recovery of lanthanides.

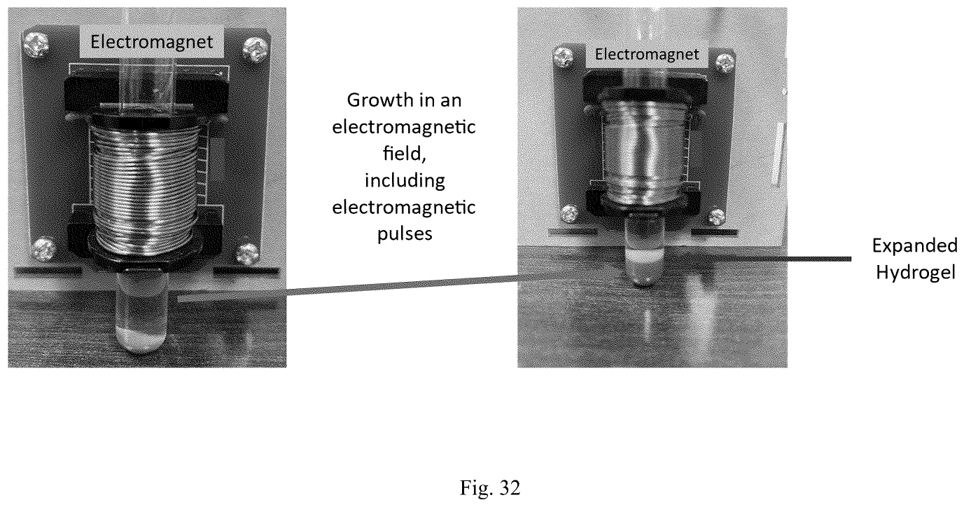

In addition to growing bacterial communities such as acidophiles, halophiles, or iron- and sulfur-reducing bacteria in magentic fields, electromagnetic fields are used to expand hydrogels during biogenic synthesis. FIG. 32 shows an electromagnetic field being applied using a coil. A glass tube with precursors and bacterial communities are inserted between the coil. This is to both apply an electromagnetic field and create more porosity. As such, these materials are designed to be responsive to magnetic fields and electrical currents. These materials can be formed by employing a magnetic field under oxic, anioxic, biotic, or abiotic conditions and the like.

### Example 2: Separation Process and Membrane Design

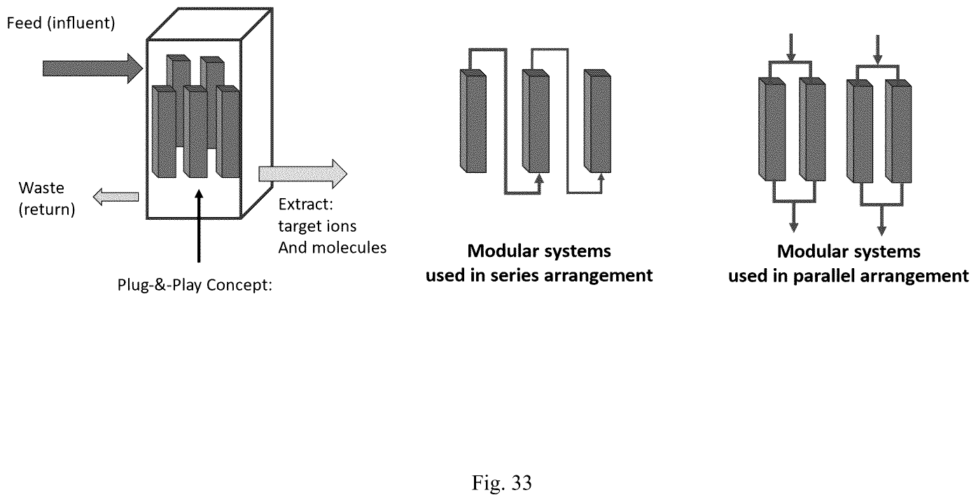

On-demand modular concepts involve a system comprising multiple modules that can be arranged in series or parallel configurations (FIG. 33). This arrangement is adaptable based on environmental conditions, feed characteristics, and the target ions and molecules. The modular plug-and-play concept, often crafted for on-demand manufacturing in the pharmaceutical industry, presents numerous benefits which could be utilized in separation systems. By leveraging modular components that can easily integrate and adapt, this approach enables rapid adjustments to changing production needs and supports scalability in various industries. In the pharmaceutical industry, where precision, flexibility, and efficiency are crucial, such a system greatly enhances responsiveness in meeting varying demand, accelerates the time-to-market for new drugs, and improves resource utilization. Overall, this concept holds promise for revolutionizing pharmaceutical manufacturing by enhancing productivity, flexibility, and responsiveness to market dynamics.

The modular separation unit embodies several key characteristics that make it uniquely suited for diverse applications. Firstly, it operates with a balance of independence and interconnectivity, allowing each module to function autonomously while maintaining seamless communication with other units. This setup ensures coordinated performance within the system, enhancing efficiency and adaptability. Secondly, the unit is characterized by its proactive responsiveness, capable of dynamically adjusting to operational and environmental changes. This adaptive nature enables the unit to sustain optimal performance even in fluctuating conditions, ensuring reliability and effectiveness in various settings. The modular separation unit offers the ability to selectively separate ions and molecules based on precise criteria like atomic radius, molecular weight, and charges. Its modular design enhances efficiency and cost-effectiveness, thanks to interchangeable operational units and low-cost maintenance features. Additionally, its ease of adjustment to changing conditions ensures reliable performance, making it invaluable in dynamic environments.

Considerations for the synthesis and fabrication of locally tuned membranes are presented:
1. Patterned Electrode Layers using Soft Lithography: Generating patterned electrode layers beneath or atop membrane surfaces enables spatially selective application of electrical fields. This method leverages elastomeric stamps for pattern transfer, overcoming limitations of traditional photolithography by enabling the patterning of delicate biological molecules and the construction of channel structures optimized for fluid dynamics at the microscale. Specifically, it facilitates the production of prototype patterns and structures with feature sizes (≥50 μm) relevant to biology, rapidly and at reduced costs.
2. Electroporation and Electrofusion: By administering brief, high-voltage pulses to a membrane, transient pores are induced, facilitating regulated molecular transport across the membrane. This method finds extensive application in biotechnology for the delivery of DNA or other compounds into cells. Electric impulses significantly enhance DNA uptake in cells, with experiments showing 95 (±3) stable transformants per million cells using electric fields (8 kV/cm, 5 microseconds). This method, termed ‘electroporation,’ is simpler and more efficient than biochemical techniques, facilitating DNA entry into cells by stabilizing membrane pores through electric field interactions with lipid dipoles.
3. Microelectrode arrays (MEAs): Microelectrode arrays (MEAs) enable precise application of localized electrical fields at the microscale, rendering them invaluable tools in neural engineering and for investigating cellular reactions to electrical stimulation. With MEAs, voltage control can be meticulously orchestrated at distinct points across a membrane surface, facilitating targeted and controlled experimentation. Three-dimensional microelectrode arrays (3D MEAs) have been recognized as valuable tools for detecting the electrical activity of tissues and organs both in vitro and in vivo, despite challenges in achieving rapid, accurate, and versatile monitoring that have limited their application in cell and tissue behavior analysis.
4. Ionic Gels and Conductive Polymers: The application of ionic gels or conductive polymers as coatings on membranes enables the imposition of voltages across the membrane surface. This approach facilitates the development of responsive surfaces capable of altering their properties, such as permeability or wettability, in reaction to electrical stimuli. Ion gel templates with widely tunable dynamics (Tg) are designed to direct the assembly of synthetic functional materials, emulating the role of dynamic surfaces in templating highly ordered complex structures found in living systems. It is hypothesized that these ion gels expedite polymer nucleation by reconfiguring their surfaces to facilitate cooperative multivalent interactions with conjugated polymers, a theory supported by both experimental and computational evidence. By varying the dynamics of the ion gel, significant modulation of alignment, molecular orientation, and crystallinity in the templated polymer thin films can be achieved.
5. Programmable Performance of Pressure Sensors Enabled by Heterophasic Ionogels with Shape and Stiffness Memory: Heterophasic ionogels with shape and stiffness memory, enabling flexible pressure sensors to exhibit tunable compressibility and programmable pressure-resistance characteristics. These ionogels blend microstructural alignment for adjustable stiffness with shape memory inclusions for stiffness retention, facilitating a balance between high sensitivity and extensive pressure range capabilities.

The present application presents a novel engineering design concept to mimic the mamalian small and large intenstine for a modular separation unit. The small intenstine, for example, is specialized for efficient absorption through features like villi and microvilli that maximize surface area and contain epithelial cells with membrane transporters for active and passive transport. Tight junctions regulate paracellular flow, while enzymes break down complex molecules. Additionally, varying local pH levels, peristalsis, and a dense capillary network contribute to optimal absorption. The enteric nervous system indirectly affects these processes by regulating motility and secretion. Passive and active trasport mechanisms emulate the small intestines filtration capabilities and achieve atomic/molecular level precision.

In some embodiments, the separation unit presented herein is designed to separate rare earth elements, ions, and molecules from complex matricies using active and passive transport mechanisms. In one approach, capillary networks will be integrated to optimize the selectivity and precision. In some embodiments, polymeric beads or rods can be added to remove ions such as calcium, magnesium, and phosphate. In some embodiments, the separation unit utilizes the porous composites described herein. In one embodiment, the inner surface of the hollow tube is coated with a porous layer of activated carbon or layered materials.

In one method, indigenous bacterial communities and genetically modified bacterial communities are employed in the separation unit for biosorption, bioaccumilation, and/or biomineralization of rare earth elements. Genetically modified bacterial communities can enhance the specificity and selectivity of the bacteria for targeting rare earth elements and improving the efficiency of separation and purification. In some embodiments, biofilm growth is enhanced to facilitate efficient electron transfer. The biosynthesized porous hydrogels described herein have naturally facilitated the growth of indigenous bacterial communities that thrive on rare earth elements such as neodymium and europium (FIG. 30). The main structure of the hydrogel is synthesized from a mineral, such as pyrite.

These hydrogels are expected to serve as aquaporin channels in the membranes described herein. These biosynthesized composites house bacterial communities that thrive on specific rare earth elements. The characteristics of such composites can be altered to exhibit specific responses to external magnetic fields and local surface potentials. In some cases, the hydrogels serve as a coating on the hollow membranes to promote biofilm growth and to directly absorb or bioaccumilate rare earth elements, such as lanthanides. Impurities and competing ions will be continuously removed through diffusion.

The is designed to be self-healing and self-cleaning. In some embodiments, the design of the membrane includes the following characteristics: tunable surface charges, tunable pore sizes, tunable pore shapes, tunable membrane tortuosity, and tunable membrane dimensions (FIG. 34). Such characteristics allow the membranes to offer precision and selective separation of dilute species, such as cations, anions, and molecules.

In some embodiments, these concepts present a laminar flow regime characterized by orderly flow layers with minimal mixing and low friction drag. The boundary layer remains stable and attached to the surface for a longer distance before transitioning to turbulence. This results in a lower critical Reynolds number for the onset of turbulence. In some embodiments, the proposed system herein operates with high fluid retention time (2 to 48 hours) and low linear velocity (0.075 to 2.5 cm/min). Thus, the expected flow regime in the system in laminar flow. In this setup, enhanced mixing within the boundary layer is achieved by coating the inner surface of hollow membranes with textured layers of MnO₂ or activated carbon to introduce surface roughness. However, the coating should be porous to enable mass transfer to the hollow fiber membrane, predominantly via diffusion.

In some embodiments, a surface coating introduces an extra layer of selective adsorption at the initial stage of the separation process. Uranium and thorium, both radioactive and toxic, present considerable challenges for extraction from a mixture of rare earth elements. In this context, foam-based activated carbon is employed as a surface coating to adsorb uranium and thorium effectively at an early stage. The foam-like activated carbon is not only effective in adsorbing uranium and thorium but also plays a crucial role in extracting other common impurities in rare earth elements.

The use of magnetic fields in microfluidic membrane pores introduces a sophisticated method for guiding molecules through membrane pores with localized magnetic variations. This technique involves modifying membrane pores to display localized magnetic properties, allowing for the levitation and directed propulsion of molecules sensitive to magnetic fields. Alternatively, the magnetic field can be used solely to tune the size and shape of the membrane pores. When magnetically tagged molecules are the target, they encounter the magnetically altered pores and are precisely guided through the membrane without direct contact, ensuring minimal resistance and high specificity in transport. This approach not only enhances the efficiency of molecular separation and transport but also opens new possibilities for targeted filtration and molecule delivery systems, highlighting the innovative application of magnetic fields in refining membrane-based technologies.

By integrating magnetic responsiveness into a porous hydrogel system, which features a network of micropores for bacterial cultivation and a larger macropore for precise molecule and ion exchange, its functionality and versatility are greatly enhanced. The hydrogels described herein are designed to dynamically respond to magnetic field alterations, granting unparalleled control over both the microenvironment for bacterial growth and the selective transport processes. The ability to adjust pore sizes and the hydrogel's overall permeability in response to magnetic fields allows for precise substance delivery and removal, akin to the functionality of natural aquaporins but with enhanced, externally modifiable control. This magnetic adaptability not only mirrors the selective properties of biological channels but also introduces a level of manipulation previously unattainable, paving the way for groundbreaking applications in microbial ecosystem research, the crafting of sophisticated biofiltration technologies, and the development of dynamically responsive bioreactors.

The integration of magnetic directional pulses across the membrane's cross-section, combined with the use of an external magnetic coil and internal magnetic and paramagnetic hydrogels, significantly refines the control and precision of the membrane's functions. These pulses generate localized magnetic fields, which can be strategically aligned to steer the movement and orientation of molecules within the membrane. This technique finely adjusts molecular pathways, facilitating the targeted transport of specific substances through various membrane regions. Such magnetic pulses dynamically modify the membrane's permeability and selectivity, allowing for the real-time opening or closing of molecular pathways. This feature is especially beneficial for establishing gradients or zones with unique transport properties within the membrane, aiding in complex separation tasks or the creation of chemically or biologically diverse environments. Additionally, directional magnetic pulses introduce an extra layer of control, enabling the adjustment of the membrane's internal conditions in response to external magnetic stimuli, without the need for physical modifications. This capability is crucial for applications that demand high precision and adaptability, including controlled drug release, precision filtering in bioprocessing, and the development of smart materials for environmental monitoring and remediation.

The combination of magnetic coils, paramagnetic hydrogels, and directional magnetic pulses represents a highly innovative approach in material design, utilizing magnetic fields to actively and precisely influence molecular transport and membrane attributes. This paves the way for significant advancements in membrane technology with wide-ranging applications in science and industry. Incorporating magnetic moment principles, akin to those used in MRI and NMR, into the membrane design offers dual benefits. It enhances the system's selectivity and control by allowing targeted manipulation of molecules based on their magnetic properties, while also offering a non-invasive method to monitor and analyze membrane performance and molecular dynamics.

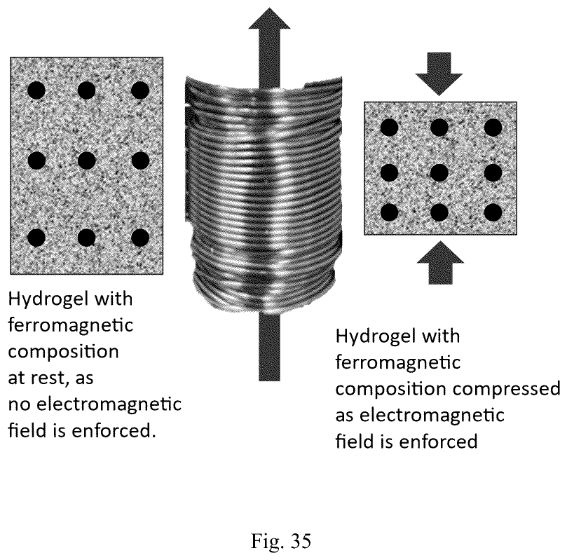

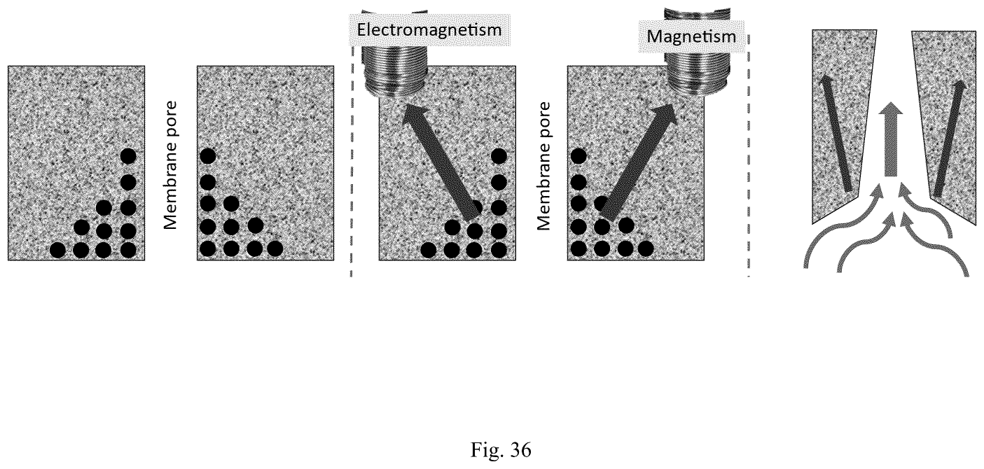

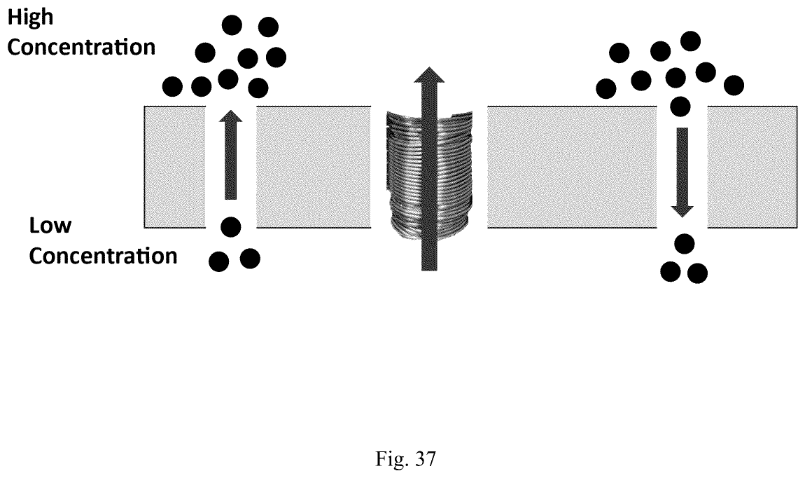

In some embodiments, the separation units described herein further incorpoate collodial materials within the hydrogels aimed at significantly enhancing mass transfer and stimulating bacterial growth. One example of these collodial materials are microscale and nanoscal induction coils which are incorporated into the structure of the membrane pores (FIG. 35). The volume or thickness of hydrogels made of composities susceptible to electromagnetic fields are expanded or compressed. The size and shape of pore openings are tuned using directional electrical magnetic fields. FIG. 35 demonstrates an approach to fine-tune hydrogels or membranes made of materials susceptible to electromagnetic fields. FIG. 36 shows the ferromagnetic composition (circles) pulling the pore to become wider as an electromagnetic field is enforced. Furthermore, electromagnetic fields are used to impose directional transmembrane mass transfer with switchable direction of induction (FIG. 37). In one embodiment, this method is used to remotely impose inductions wirelessly to coils incorporated in the membrane.

In one embodiment, the pores are coiled to provide electromagnetic fields to attract magnetic nanoscale and two dimensional (2D) adsorbents. However, this application is not limited to the use of nanoscale and 2D adsorbents. The size of the pores can vary from a few millimeters to nanometers depending on the application and type of adsorbent used.

FIG. 38 shows a cross-section of the electromagnetic pores. Fluids enter the filtration system as such that the adsorbates are readily adsorbed to the membrane material. In one embodiment, the coiled pores provide electromagnetic fields to capture the magnetic adsorbents over the separation phase and treated fluid(s) leave the electromagnetic pores without magnetic adsorbents. In this representation, the filtration system runs until the electromagnetic pores become saturated. After saturation of the pores, electromagnetic fields are switched off to release and recycle the adsorbents as shown in FIG. 39, where electromagnetic fields are deactivated, and a cleansing fluid is pushed through the pores to recover the magnetic adsorbents.

In one embodiment, the fluids containing magnetic adsorbents are pushed through electromagnetic pores where magnetic adsorbents are attracted to electromagnets and purified fluids leave the purification module without the magnetic adsorbents as shown in FIG. 40. Once the pores are saturated the cleansing process is similar to the previously shown process as shown in FIG. 39. In the above-mentioned examples, pore geometry and dimensions simply remain the same throughout the processes or can be fine-tuned as already explained. The electromagnetically tunable pores can change their geometry, dimensions, and surface charge, in response to locally applied electromagnetic fields or radio frequencies.

In one embodiment, pores have multiple layers and segments of electromagnetically and radio frequency responsive materials where vertically oriented coils are switched on and off. In another embodiment, voltages and currents are adjusted as such that the length of the pores are altered in response to locally exerted magnetic, electromagnetic fields or forces or radio frequencies. The use of electromagnetic and radio frequency (RF) shielding materials and elastomers in combination with electromagnetic or RF responsive materials allow the local application of magnetic, electromagnetic, and radio frequency fields and forces. A simplified example of a vertically oriented coil system comprising electromagnetic pores is depicted in FIG. 41. In one embodiment, sensors continuously measure analytes in the fluids and the collected data is provided to a processor (e.g., a GPU/CPU of computer 1000). With the use of advanced artificial intelligence (AI) systems, parameters such as voltages and currents are calculated, and signals are sent to a controller to regulate current and voltages in the coils as such that pores are finely tuned to yield the optimal operational conditions for the pores. Also, as shown in FIG. 41, coil densities can vary in each section depending on the electromagnetic forces needed.

In one embodiment, the pores consist of multiple layers and segments made from materials responsive to electromagnetic and radio frequencies. Horizontally oriented coils are employed to modify the inner dimensions, geometry, and tortuosity of the pores, as shown in FIG. 42.

In another embodiment, a combination of vertically and horizontally oriented coils are used to finely tune the geometry or dimensions of the pores. In an example, a combination of responsive and shielding materials with metallic scaffolds ensure that electromagnetic fields are locally applied.

In one embodiment, the electromagnetic pores have fixed geometry and dimensions. The electromagnetism can be switched on during purification and switched off during cleansing phases, with no changes in shape and dimensions of the pores. Thus, cycles of generating electromagnetic fields do not change the pores' structure. However, the voltage can vary from millivolts to 100 volts depending on the use of magnetic adsorbents and pores sizes and materials.

In another embodiment, the dimensions and geometry of pores are controlled and adapted in response to changes in the environmental and operational conditions. Simpler applications of such electromagnetically controlled purification systems are in the use of separation systems in which pore sizes change depending on the particulate matters which need to be removed from the fluids. These pores could be in the range size of millimeters to micrometers and higher voltages are used to control the pores.

In more advanced applications, the geometry and dimensions of pores change in response to environmental and operational conditions in the ranges of nano to picometers. In one embodiment, the hydrogels described herein (FIG. 28) respond to specific ranges of magnetic fields, electromagnetic fields, and radio frequency, such as microwaves, and frequency ranges of 300 Megahertz (MHz) to 300 Gigahertz (GHz).

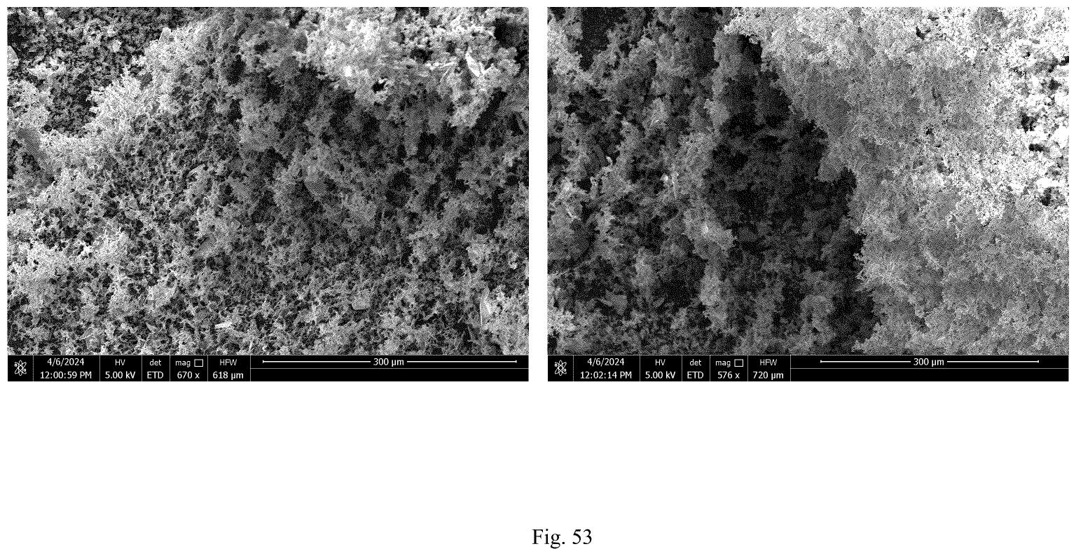

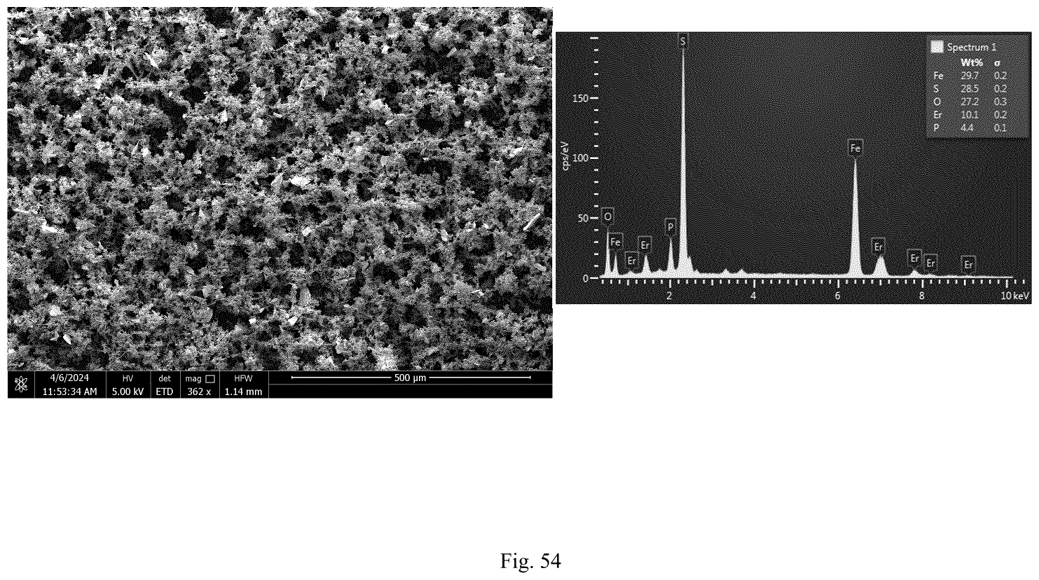

In one embodiment, pyrite (FeS₂) is used as a precursor under the disclosed conditions and processes, to generate a porous hydrogel with iron-based scaffolds. In another embodiment, lanthanide elements such as gadolinium (Gd) and neodymium (Nd) are used to adjust the response to magnetic and electromagnetic fields, and radio waves, with and without pyrite. Metalloids such as boron (B) and post-transition metals such as aluminum (Al) are used in trace concentrations to adjust the structure of the pores and their response to magnetic and electromagnetic fields. FIG. 53 and FIG. 54 depict yttrium and erbium doped crystals grown under the influence of a magnetic field.

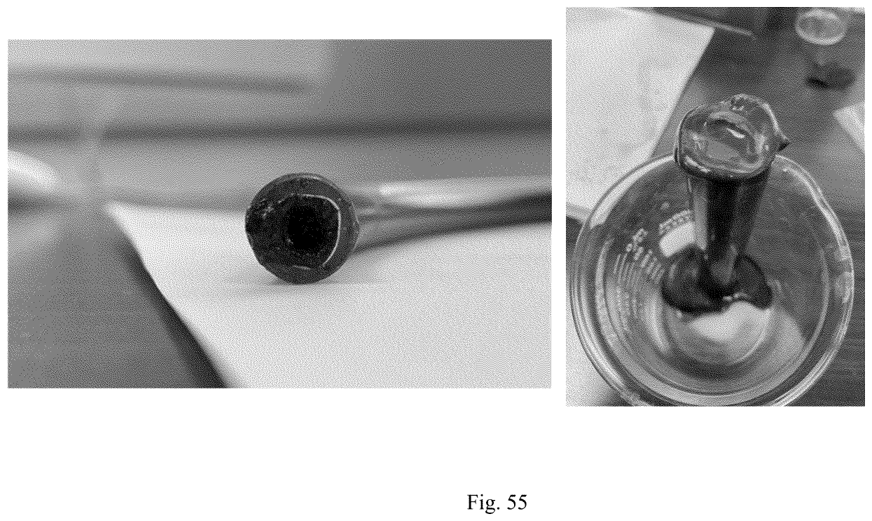

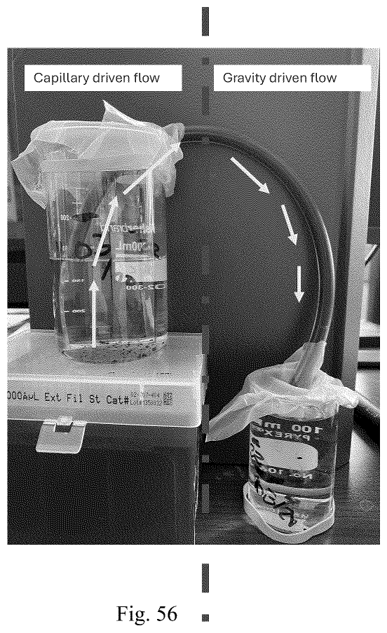

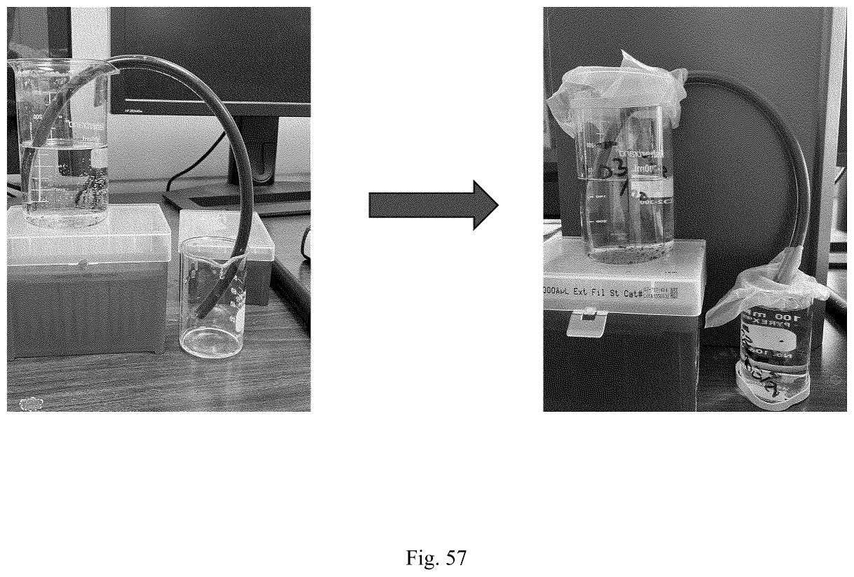

In one embodiment, packing a tube with graphene, graphite, or carbon nanotubes can create capillary pathways at micro and nanoscale (FIG. 55). These capillary pathways can be used for fluid flow or flow of ions or salts. Desalination or charge and discharge of batteries are two examples of the anticipated applications. By using two a tube between two beakers at different elevations, gravity can also be used to enhance the flow of fluids, ions, or salts, wherein flow of fluid is driven by both capillary and gravity (FIG. 56). FIG. 57 shows the use of capillary and gravity forces to move highly saline fluid from one beaker to another.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

We claim:

1. A membrane material having a first surface, an opposing second surface and a thickness between the first and second surfaces;
the membrane material comprising a mineral comprising a metal selected from the group consisting of iron, boron, indium, lithium, aluminum, magnesium, titanium, vanadium, manganese, gadolinium, neodymium, molybdenum, and combinations thereof; and at least one channel between the first surface and the second surface, wherein the channel has a diameter of less than 1 mm.

2. The membrane material of claim 1, wherein the mineral is pyrite (Fe₂S) and the membrane material further comprises a rare-earth metal.

3. The membrane material of claim 2, wherein the rare-earth metal is selected from the group consisting of erbium, europium, gadolinium, neodymium, uranium, thorium, plutonium, neptunium, americium, curium and combinations thereof.

4. The membrane material of claim 1, further comprising a microorganism.

5. The membrane material of claim 1, wherein the microorganism is bacteria.

6. The membrane material of claim 1, wherein the pH of the membrane material is below 7.

7. The membrane material of claim 1, wherein the membrane material forms a cylinder with the at least one channel passing through the length of the cylinder.

8. The membrane material of claim 1, wherein the membrane material forms a sheet with the at least one channel passing through the thickness of the sheet.

9. A purification system comprising:
a first chamber and a second chamber, wherein the membrane material of claim 1 is positioned between the first chamber and the second chamber and configured to permit a fluid to pass from the first chamber into the second chamber through the membrane material;
a power supply; and
at least one magnet electrically connected to the power supply, the at least one magnet configured to generate a magnetic field, wherein the at least one magnet is positioned adjacent to the membrane material such that at least a portion of the membrane material resides within the generated magnetic field.

10. The purification system of claim 9, wherein the membrane material is configured to change in size, shape, surface charge, tortuosity, or combinations thereof, in response to the generated magnetic field.

11. The purification system of claim 10, wherein the change in the membrane material comprises a change in size, shape, surface charge, tortuosity, or combinations thereof, of the at least one channel.

12. The purification system of claim 11, wherein the change in the membrane material responsive to the generated magnetic field comprises an increased diameter of the at least one channel.

13. The purification system of claim 11, wherein the change in the membrane material responsive to the generated magnetic field comprises a decreased diameter of the at least one channel.

14. The purification system of claim 11, wherein the change in the membrane material responsive to the generated magnetic field comprises a gradual increase in diameter of the at least one channel towards the first surface of the membrane material.

15. The purification system of claim 11, wherein the change in the membrane material responsive to the generated magnetic field comprises a gradual decrease in diameter of the at least one channel towards the second surface of the membrane material.

16. The purification system of claim 11, wherein the change in the membrane material responsive to the generated magnetic field comprises a gradual increase in diameter of the at least one channel towards the first surface of the membrane material and a gradual decrease in diameter of the at least one channel towards the second surface of the membrane material.

17. The purification system of claim 11, wherein the at least one channel comprises at least two channels, wherein the change in the membrane material responsive to the generated magnetic field comprises a first change in diameter of a first channel and a second change in diameter of a second channel, wherein the first and second changes in diameter are different.

18. The purification system of claim 11, wherein the at least one magnet is a magnetic coil.

19. The purification system of claim 11, wherein the power supply is communicatively connected to a computing environment configured to control the generation of the magnetic field via the power supply.

20. The purification system of claim 19, wherein the computing environment is controlled by an artificial intelligence unit.

21. The purification system of claim 18, wherein the sensor is selected from the group consisting of: glass electrode pH sensors, ion-sensitive field-effect transistor sensors, calorimetric sensors, optical sensors (absorbance/transmittance), conductivity sensors, refractometers, near-infrared sensors, resistance temperature detectors, thermocouples, thermistors, infrared sensors, multi-parameter probes, wireless sensors, photoionization detectors, flame ionization detectors, and combinations thereof.

22. The purification system of claim 18, wherein the at least one parameter is selected from the group consisting of: pH, conductivity, pressure, humidity, gas concentrations, velocity of fluids and particulates, magnetic fields, temperature, concentration of specific salts, ions, and molecules, and combinations thereof.

23. The purification system of claim 9, further comprising an electromagnetically shielding material selected from the group consisting of: conductive silicone rubbers, carbon-black filled rubbers, silver-coated rubbers, graphene-based rubbers, metal-loaded rubbers, thermoplastic elastomers with conductive fillers, polyurethane elastomers with conductive carbon, natural rubber with conductive fillers, and combinations thereof.

24. The purification system of claim 9, further comprising an electromagnetically responsive material selected from the group consisting of: piezoelectric materials, ferromagnetic particles, conductive polymers, photonic crystals, graphene, magnetic materials, magnetic minerals, rare-earth elements, superconducting materials, plasmonic materials, and combinations thereof,

25. A method of purifying a fluid, the method comprising the steps of:
passing a feed solution comprising a particulate through a membrane material, the membrane material comprising a mineral comprising a metal selected from the group consisting of iron, boron, indium, lithium, aluminum, magnesium, titanium, vanadium, manganese, gadolinium, neodymium, molybdenum, and combinations thereof, the membrane material further comprising at least one channel through a thickness of the membrane material, wherein the channel has a diameter of less than 1 mm;
absorbing the particulate in the membrane material to create a recovery solution; and
collecting at least one of the recovery solution and the particulate.

26. The method of claim 25, further comprising the steps of:
applying a magnetic field or an electrical stimulus to at least a portion of the membrane material; and
changing the membrane material in size, shape, surface charge, tortuosity, or combinations thereof, in response to the applied magnetic field or electrical stimulus.

27. The method of claim 26, wherein the change in the membrane material responsive to the applied magnetic field or electrical stimulus comprises an increased diameter of the at least one channel.

28. The method of claim 26, wherein the change in the membrane material responsive to the applied magnetic field or electrical stimulus comprises a decreased diameter of the at least one channel.

29. The method of claim 26, wherein the change in the membrane material responsive to the applied magnetic field or electrical stimulus comprises a gradual increase in diameter of the at least one channel towards the first surface of the membrane material.

30. The method of claim 26, wherein the change in the membrane material responsive to the applied magnetic field or electrical stimulus comprises a gradual decrease in diameter of the at least one channel towards the second surface of the membrane material.

31. The method of claim 26, wherein the change in the membrane material responsive to the applied magnetic field or electrical stimulus comprises a gradual increase in diameter of the at least one channel towards the first surface of the membrane material and a gradual decrease in diameter of the at least one channel towards the second surface of the membrane material.

32. The method of claim 26, wherein the change in the membrane material responsive to the applied magnetic field or electrical stimulus comprises a first change in diameter of a first channel and a second change in diameter of a second channel, wherein the first and second changes in diameter are different.

33. The method of claim 26, further comprising the step of controlling application of the magnetic field or the electrical stimulus via a computing environment.

34. The method of claim 33, further comprising the step of controlling the computing environment via an artificial intelligence unit.
